(19) United States
(12) Patent Application Publication
(10) Pub. No.: US 2003/0232117 A1
(43) Pub. Date: Dec. 18, 2003

(54) Confections that "swim" in a carbonated beverage

(76) Inventor: Laurence J. Shaw, San Francisco, CA (US)

Correspondence Address: Laurence J. Shaw, 3627 Sacramento Street, San Francisco, CA, 94118, US

(21) Appl. No.: 10/459,225

(22) Filed: Jun. 11, 2003

Related U.S. Application Data
(60) Provisional application No. 60/388,018, filed on Jun. 12, 2002.
(60) Provisional application No. 60/407,507, filed on Aug. 30, 2002.

(51) Int. Cl. A23L 2/40

(52) U.S. Cl. 426/591; 426/660

(57) ABSTRACT

An edible confection which repeatedly rises and sinks, i.e., “swims,” in a transparent carbonated beverage due to changing buoyancy resulting from the formation of carbonation bubbles on the surface of the confection, and the escape of the bubbles to the atmosphere when the confection reaches the top of the beverage. An edible surfactant is included as a soluble coating on the confection to influence the confection-atmosphere surface tension, confection-beverage surface tension, and/or beverage-atmosphere surface tension such that the surface tension at the top of the beverage does not inhibit or prevent descension of the confection. Preferably, the surfactant is a powdered gelatin. The coating may also include ingredients which promote the solution of the gelatin. Alternatively, for confections having a liquid coating, the viscosity and thickness of the coating are engineered, and/or the underlying surface is roughened to minimize the sliding of carbonation bubbles when the surface is inclined. The confections are die-cut from a thin multi-color sheet, and discharged onto a packaging card by heating the die to melt the edges of the confections, and applying air pressure. The melted edges act to bond the confections to the packaging card. The confections are powdered with the surfactant while the edges are molten, and therefore only the edges substantially retain the coating powder.

### CROSS-REFERENCE TO RELATED APPLICATIONS

The present application is based on and entitled to the benefit of provisional patent application serial No. 60/388,018, filed Jun. 12, 2002, by the same inventor and having the same title, and provisional patent application serial No. 60/407,507, filed Aug. 30, 2002, by the same inventor and having the same title.

### FIELD OF THE INVENTION

The present invention relates generally to toys and amusements, particularly to edible toys and amusements, more particularly to edible toys and amusements with kinetic properties, and even more particularly to edible toys and amusements with kinetic properties in carbonated beverages.

### BACKGROUND OF THE INVENTION

A well-known demonstration of varying buoyancy involves putting raisins (see Sink Or Swim!: The Science of Water, by Barbara Taylor, Random House Publishing, New York, 1990, page 22) or small clay balls (see Physics For Every Kid, by Janice Pratt VanCleave, John Wiley & Sons, Inc., New York, 1991, pages 64-65) in a carbonated beverage with no ice. (For convenience this paragraph will refer to the motion of raisins, although it should be noted that the clay balls behave in the same manner.) The raisins initially sink, since their specific gravity is greater than unity. When the population of carbon dioxide bubbles which forms on the surface of a submerged raisin reaches a sufficient volume, the raisin is lifted to the surface of the beverage. Then, at the surface of the beverage those bubbles which come in contact with the beverage/air interface escape into the air, leaving the raisin/bubble ensemble with a density greater than that of the beverage and so the raisin again sinks, beginning another cycle of motion. (Henceforth in the present application the repeated ascents and descents of an article in a carbonated beverage due to the changing buoyancy of the article and attached carbonation bubbles will be referred to as “swimming.”)

Operating on a similar principle is a plastic toy which is shaped like a submarine and has an interior chamber for holding a charge of baking powder (such as the Undersea Explorer™ manufactured by DaMert Company of San Leandro, Calif.). The baking powder is loaded in the chamber by first submerging the submarine in a vessel of water to wet a screen at the bottom of the chamber, shaking the submarine to remove most of the water from the chamber while retaining some water in the screen, loading the baking powder into the chamber through a top port, and sealing the top port. When the submarine is then put in the water, it will descend since the plastic and baking powder has a specific gravity greater than that of water. However, when water enters the chamber via the screen at the bottom of the chamber, a chemical reaction between the water and the baking powder produces gases in the chamber which change the buoyancy of the submarine, inducing it to ascend. When the volume of the gasses becomes sufficiently large, the bubble formed against the screen at the bottom of the chamber dislodges from the submarine, and the submarine again descends to begin another cycle of motion.

U.S. Pat. No. 6,319,535 teaches edible confections with recognizable shapes that repeatedly rise and sink, i.e., “swim,” in a transparent carbonated beverage due to changing buoyancy resulting from the formation of carbonation bubbles on the surface of the confection, and the escape of the bubbles to the atmosphere when the confection reaches the top of the beverage. The activity of a confection (i.e., the number of descents per minute) is a function of the density, volume, and surface area of the confection, and the volume per unit area of carbonation bubbles which form on the confection. U.S. Pat. No. 6,319,535 teaches that for thin confections the activity is substantially independent of the dimensions other than the thickness. FIG. 2 is a plot from U.S. Pat. No. 6,319,535 of activity versus thickness for articles in a carbonated beverage. As can be seen from FIG. 2, the activity is monotonically increasing with thickness until the articles under investigation reach a thickness of approximately 4 mm. There is apparently a first activity plateau for thicknesses between approximately 2.0 and 2.25 mm, a second activity plateau for thicknesses between 2.5 and 3.0 mm, and a third activity plateau for thicknesses between 3.5 and 4.25 mm. At thicknesses greater than or equal to Tₘₐₓ=4.5 mm the articles are too heavy to ascend. As confirmed by observation, for thicknesses up to and including the first plateau, bubbles must leave both sides of an article for it to descend. For thickness corresponding to the second and third plateaus, the bubbles need only leave the top surface of the article for it to descend. Furthermore, for the larger thicknesses in the third plateau only a small portion of the bubbles on the top of the article need leave the article for it to descend.

A standard process (400) for manufacturing a gummy candy slurry (436) is depicted in FIG. 5A, with process steps depicted as rectangular boxes and physical components depicted as ellipses. (It should be noted that not all physical components are depicted in the flowcharts of the present specification and, for the physical components which are depicted in the flowcharts, not all modifications or intermediate states of the physical components are explicitly depicted. For instance, both the output of process step (410) and the output of process step (415) are referred to as the raw slurry (411) although the output of step (415) has in addition been cooked under back pressure.) The four main ingredients used in the manufacturing of gummy candies are gelatin (401), water (402), corn syrup (403), and sugar (404). In the first step of the manufacturing process (400), the gelatin (401) is dissolved (405) in water (402) to produce a gelatin solution (406). The gelatin solution (406) is transported to a kettle mounted on a scale where precisely measured amounts of corn syrup (403) and sugar (404) are mixed (410) with the gelatin solution (406) to produce a raw slurry (411). To fully dissolve the crystalline sugar (404) in the raw slurry (411), the raw slurry (411) is fed to a cooking system which cooks (415) it (411) in a cooking coil under backpressure. The backpressure prevents the raw slurry (411) from boiling when the temperature is raised sufficiently to dissolve the sugar (404). The raw slurry (411) is then cooled (420) in a vacuum chamber. The near-zero atmospheric pressure in the vacuum chamber, besides lowering the temperature of the slurry (411), draws off a portion of the water content to produce a cooked slurry (421). This (420) is commonly referred to as the ‘flash-off’ stage of the manufacturing process (400).

The cooked slurry (421) is transported to a dosier, where the cooked slurry (421) is mixed (425) with colorings and flavorings (424) (such as citric acid, acetic acid, and fruit juices) to produce the gummy candy slurry (426). The choice of colorings and flavorings (424) will vary according to the product to be manufactured. The mixing occurs in mixing pots, and the colorings and flavorings (424) are measured out using sight glasses, i.e., cylindrical glass tubes equipped with sensors for monitoring the amount of the contained ingredients, and feedback circuitry for controlled filling of the tubes based on the sensor information.

A standard process (500) for manufacturing gummy candies using the gummy candy slurry (426) is depicted in FIG. 5B, with process steps depicted as rectangular boxes and physical components depicted as ellipses. The candy slurry (426) is deposited (505) into trays of starch molds using one or more pour heads. Typically, a pour head is a cylindrical chamber with an intake/output nozzle. Within the cylindrical chamber is a movable piston. The candy slurry (426) is sucked into the chamber via the nozzle upon the upstroke of the piston, and extruded through the nozzle upon the downstroke of the piston. The tray of filled molds is brought to a drying room for drying (510), typically for a period of 24 to 48 hours. Once the candy slurry (426) has hardened to a consistency typical of gummy candies, the tray of starch and candy is tipped (515) into a sieve. The sieve separates the candies (516) and starch (517) since the starch (517) passes through the sieve. The starch (517) is augered and cleansed (525) to remove moisture and bacteria, and the empty tray (518) is cleaned (520) using some combination of scrapers, brushes, air blowers, etc. The cleaned empty tray (518) is then refilled (530) with the augered and cleansed starch (517). The starch (517) in the tray (518) is then leveled (535) to insure uniformity for later stages of the molding process. The molds for the candies are made by imprinting the leveled starch using a moldboard. The moldboard is a flat plate the size of the tray (518) with a set of protruding moldpieces. Pressing (540) the moldboard into the tray (518) of starch (517) compresses the starch (517), and the indentations produced by the moldpieces form the candy molds which are filled (505) with candy slurry (426) as described above.

Once the candies (516) are separated from the starch (517) by tipping (515) the tray (518) of starch (517) and candy (516) onto the sieve, any remaining starch (517) on the candies (516) is removed (545) by directing compressed air jets onto the candies (516) to produce cleaned candies (546). The starch (517) removed at this stage (545) is combined with the starch (517) removed by tipping (515) the candies (516) into the sieve, and the totality of the starch (517) is actually augered and cleansed (525).

The cleaned candies (546) generally have a sticky surface which makes further manipulation difficult, and which may be unappealing to the consumer. Therefore, cleaned candies (546) are coated with an oil or a coating powder (556), such as powdered sugar, to reduce their stickiness, and possibly enhance the flavor and/or appearance. If the candies (546) are to be coated with a powder (556) (i.e., ‘sanded’) the candies (546) are briefly exposed (550) to steam to increase the stickiness of their surfaces. The candies (546) are then hurled (555) through a sheet of falling coating powder (556) and into a rotating drum where loose coating powder (556) in the drum coats any remaining uncoated surfaces of the candies (546) as they are tumbled (560) for roughly one minute. The candies (546) are then cooled (565), typically by transporting them on an extended conveyor belt below a series of fans. An extended conveyor belt may be implemented in a relatively confined space by conveying the candies (546) on a series of connecting belts in a zig-zag arrangement. However, if the candies (546) are to be oil coated, the candies (546) are simply put in a rotating oiling drum, where the oil within the drum coats (570) the candies (546) as they tumble. Once the candies (546) are sanded (550), (555), (560) and (565) or oiled (570), they are inspected (575) for defects and foreign materials, and packaged (580). The packaging process generally involves a series of conveyor belts, chutes, vibrating feeds (to create a uniform spatial distribution of candies), scales, electronic sensors, and electronic controls. The gummy candies may be packaged in flexible hanging bags for a pegboard, flexible bags for packing in display trays, bulk bags, large or small plastic tubs, flexible stand-up bags, or flexible bags with a paper header cap.

One of the primary advantages of molding gummy candies in starch molds is the ease which a change-over from one mold shape to another can be made by switching moldboards. However, a limitation of starch molds is that the side surfaces of the molds must have an outwards slope. The side surfaces of the mold cannot have any overhangs or any substantially vertical portions, or else a moldpiece cannot be withdrawn from the starch (517) without damaging the contour of the mold. Furthermore, with the molding process (500) described above in conjunction with FIG. 5B, the finite (i.e., non-zero) surface tension of the candy slurry (426) results in a number of limitations. The surface tension of the slurry will affect small pours, and since the surface tension determines the droplet size of the candy slurry (546) (i.e., the size of a drop of the candy slurry (426) released from a narrow, downwards-facing nozzle), pours below a certain size cannot be produced, and pours which are not at least several multiples of the minimum droplet size are difficult to control. Another limitation resulting from the finite surface tension of the candy slurry (426) is that the mold cannot have any narrow channels, i.e., channels with a diameter considerably less than the diameter of a droplet of the candy slurry (426), or surface regions with a radius of curvature considerably smaller than the radius of curvature of a droplet of the candy slurry (426). Therefore, many types of fine details cannot be molded. Another limitation resulting from the finite surface tension of the candy slurry (426) is that the mass of each candy must be large enough that the dispensing of the candy slurry (546) through the nozzle of the pour head is not inhibited by the surface tension. Another limitation of molding using starch molds as described above with a candy slurry (546) having a finite surface tension is that the upper edges of the molded candies will have rounded edges-the larger the surface tension, the larger the radius of curvature of the upper edges. (It should be noted that the geometric constraints described herein are in reference to the orientation of candies in molds with an open upper surface.)

The objects of the present invention are motivated by limitations of the prior art, including prior art not discussed herein, and/or advantages of the present invention, including but not limited to those described below.

### SUMMARY OF THE INVENTION

A confection for submersion in a beverage, the confection having a specific gravity, volume, surface area, and bubble retension properties such that the confection repeatedly ascends and descends as the carbonation bubbles which form on the confection change its buoyancy. The area and circumference of the surface of the confection exposed to the atmosphere when the confection reaches the upper surface of the beverage, the surface tension of the beverage-atmosphere interface, the contact angle of the beverage-atmosphere interface with the confection, and the bubble population volume per unit surface area after a cycle time are controlled such that the beverage-atmosphere surface tension does not prevent the confection from descending.

A tool for die cutting candies from a candy sheet having a master pressure tube which bifurcates into subsidiary pressure tubes. The ends of the subsidiary pressure tubes are co-planar and form cutting edges of a cutting die. The tool includes a first pump, or the like, for applying a negative pressure via the master pressure tube and the subsidiary pressure tubes to the cutting edges to retain material spanning the cutting edges. The tool includes a second pump, or the like, for applying a positive pressure via the master pressure tube and the subsidiary pressure tubes to the cutting edges to expel material spanning the cutting edges.

A tool for die cutting candies from a candy sheet which includes a means for heating the cutting edges of the cutting die above the melting temperature of the candies.

A tool for die cutting candies from a candy sheet having a master pressure tube which bifurcates into subsidiary pressure tubes. The ends of the subsidiary pressure tubes are co-planar and form cutting edges of a cutting die. The tool includes a means for applying a negative pressure to the subsidiary pressure tubes via the master pressure tube to retain positives cut by the cutting die, and a means for applying a positive pressure to the subsidiary pressure tubes via the master pressure tube to discharge positives cut by the cutting die.

A method for producing candies from a candy sheet by severing the candy sheet with a cutting die to produce a group of positives, withdrawing the cutting die from the candy sheet while retaining the positives in the cutting die, positioning the cutting die at a positives collection area, and expelling the positives from the cutting die into the positives collection area.

### BRIEF DESCRIPTION OF THE FIGURES

The accompanying figures, which are incorporated in and form a part of this specification, illustrate embodiments of the invention and, together with the description given above and the detailed description of the preferred embodiments given below, serve to explain the principles of the invention.

FIGS. 1A, 1B, 1C, 1D, 1E, 1F and 1G show a time sequence of side views of a “swimming” confection in a carbonated beverage.

FIG. 2 plots descents per minute per confection versus thickness for confections in a carbonated beverage.

FIG. 3A depicts the contact angle and surface tension vectors for a carbonation bubble on a submerged confection.

FIG. 3B depicts the contact angle and surface tension vectors for a bead of liquid on a confection.

FIG. 3C depicts a confection which is wetted by a liquid.

FIG. 3D depicts the contact angle and liquid-atmosphere surface tension vectors for a confection at the surface of a liquid, where a portion of the confection is exposed to the atmosphere.

FIG. 4 depicts an air bubble on an inclined, rough surface.

FIG. 5A is a flowchart showing a standard process for manufacturing gummy candy slurry.

FIG. 5B is a flowchart showing a standard process for manufacturing a gummy candy from gummy candy slurry.

FIG. 6A is a flowchart showing a process according to the present invention for manufacturing a gummy candy from gummy candy slurry.

FIG. 6B is a flowchart showing an alternate process according to the present invention for manufacturing a gummy candy from gummy candy slurry.

FIG. 7A shows a die used in the manufacturing of a gummy candy according to the present invention.

FIG. 7B shows a sheet of candy material which has been cut with the die of FIG. 7A.

FIG. 7C shows the positive sections extracted from the sheet of candy material of FIG. 7B using the tool of FIG. 7A.

FIG. 8A is a flowchart showing a modification of the process of FIG. 6A for manufacturing a gummy candy from gummy candy slurry.

FIG. 8B is a flowchart showing an alternate modification of the process of FIG. 6A for manufacturing a gummy candy from gummy candy slurry.

FIG. 9A shows a plan view of a tray with dollops of liquified gummy material of a variety of colors.

FIG. 9B shows the tray of FIG. 9A after the liquified gummy material has spread and solidified.

### DETAILED DESCRIPTION OF THE PREFERRED EMBODIMENTS AND UNDERLYING PHYSICAL PRINCIPLES

1. Overview

Reference will now be made in detail to preferred embodiments of the confections of the present invention and the physical principles underlying the swimming of the confections in a carbonated beverage. While the invention will be described in conjunction with the preferred embodiments and the underlying physical principles, it should be understood that these descriptions are not intended to limit the invention to the described embodiments, and the accuracy of the description of the underlying physical principles, and the accuracy of the approximations made in the analysis of the physical principles are also not intended to limit the scope of the invention. On the contrary, the invention is intended to cover alternatives, modifications and equivalents which may be included within the spirit and scope of the invention as defined by the appended Claims and their equivalents.

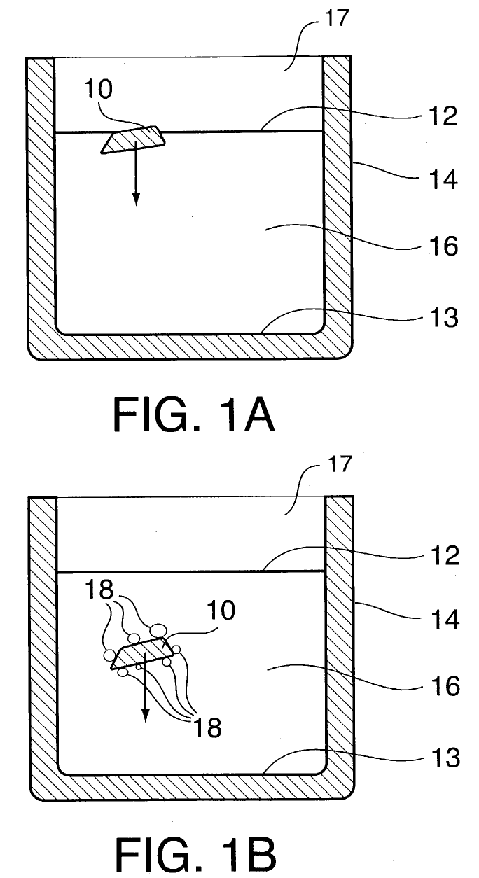

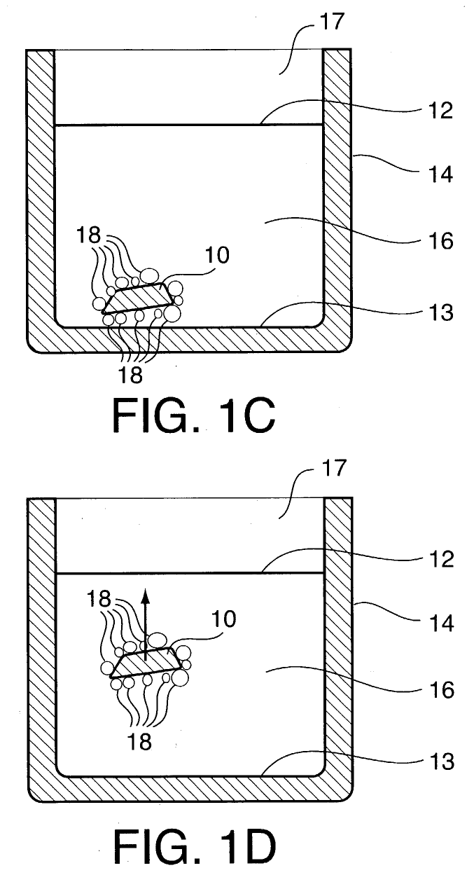

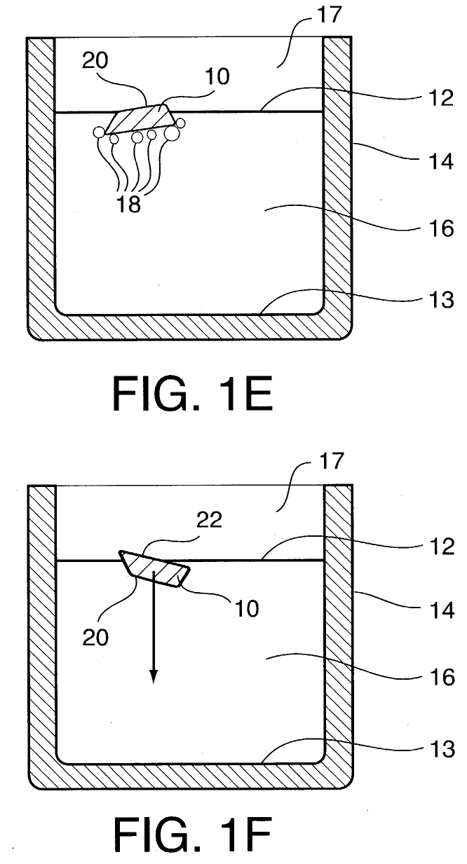

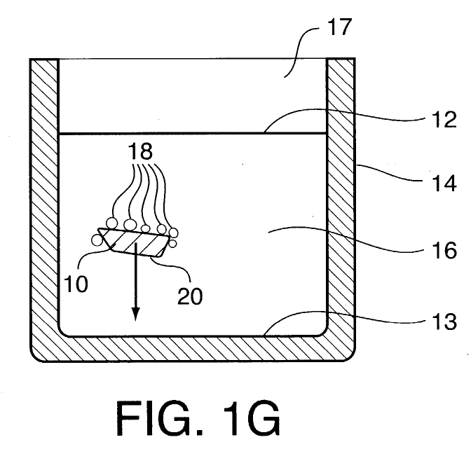

As shown schematically in FIG. 1A, when a confection (10) according to the present invention is initially put in a cup or glass (14) containing a carbonated beverage (16), the confection (10) will descend to the bottom (13) of the beverage (16) if it is more dense than the beverage (16). While descending, carbonation bubbles (18) form on the confection (10) as shown in FIG. 1B. (Although carbonation bubbles also form on the walls of the cup (14), such bubbles are not shown in FIGS. 1A-1G for clarity. Furthermore, although the appearance of swimming confections is most dramatic when a number of confections are swimming simultaneously, for simplicity of depiction only a single confection (10) is shown in FIGS. 1A-1G.) As the confection/bubbles ensemble (10, 18) rests at the bottom (13) of the beverage (16), bubbles (18) continue to form on the surface of the confection (10) and grow in size, as shown in FIG. 1C, until the overall density of the confection/bubbles ensemble (10, 18) is less than that of the beverage (16), at which point the confection/bubbles ensemble (10, 18) rises through the beverage (16), as shown in FIG. 1D. When the confection/bubbles ensemble (10, 18) reaches the top (12) of the beverage (16), the bubbles which had been on the top surface (20) of the confection (10) escape into the atmosphere (17), as shown in FIG. 1E.

Ignoring for the moment the effect of the surface tension of the top surface (20) of the beverage (16), if the confection (10) is not too flat then at this point the confection (10) will rotate so that what had previously been a lower surface (22) also comes into contact with the top (12) of the beverage (16). The bubbles on this surface (22) also escape into the atmosphere (17), as shown in FIG. 1F, and the confection (10) will again descend.

However, (still ignoring the effect of the surface tension of the top surface (20) of the beverage (16)) if the confection (10) is sufficiently flat it will not rotate until it begins descending from the top surface (12) of the beverage (16), at which point the confection (10) will rotate so the surface which had previously been the bottom surface (22) becomes the top surface, as shown in FIG. 1G. The confection/bubble ensemble (10, 18) descends to the bottom (13) of the beverage (16), and remains there until the bubbles (18) on confection (10) again grow to sizes sufficient to cause the confection/bubble ensemble (10, 18) to rise through the beverage (16).

The bubbles (18) on the confection (10) do not simply grow continuously in size. When two adjacent bubbles on a surface grow to a size such that they touch with sufficient force, they coalesce to form one bubble with a volume equal to the sum of the volumes of the two original bubbles. Generally, the new bubble is located near the position of the larger of the two original bubbles. Furthermore, when a bubble on a surface with a normal vector at an angle Ω from vertical grows to have a radius greater than a maximum bubble radius R(Ω), or when two bubbles coalesce to form a single bubble with a radius greater than the maximum bubble radius R(Ω), the buoyancy force exerted by the surrounding fluid is greater than the force with which the bubble is attached to the surface, and the bubble detaches from the surface and rises through the beverage. The maximum bubble radius R(Ω) depends on the texture of the surface, and the surface tensions between the confection and carbon dioxide, the confection and the beverage, and the carbon dioxide and the beverage. As the normal vector of the surface tilts away from vertical, the value of R(Ω) typically decreases with orientation angle Ω for 0°≦Ω≦90°, and typically increases with orientation angle Ω for 90°≦Ω≦180°.

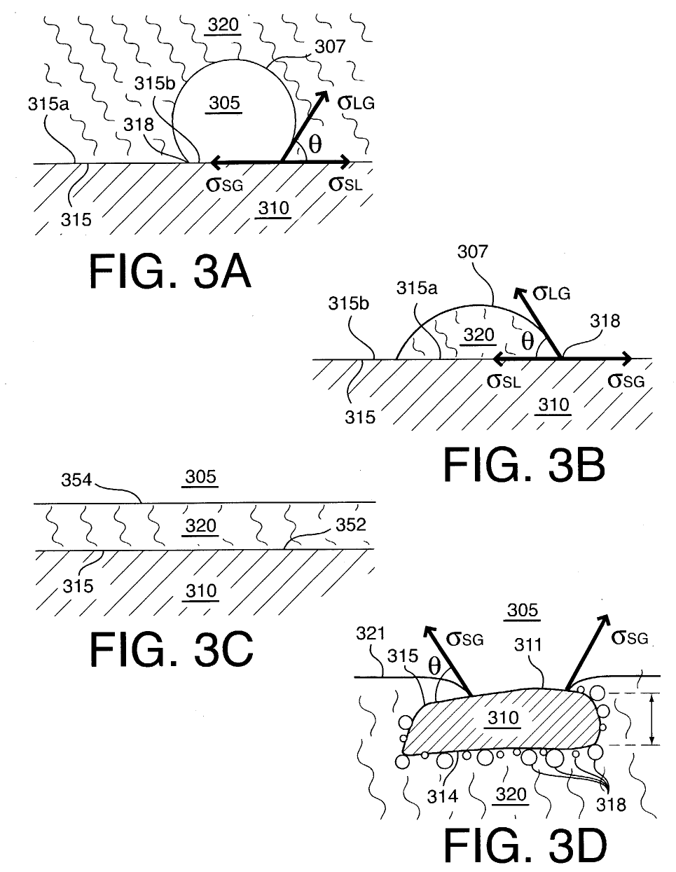

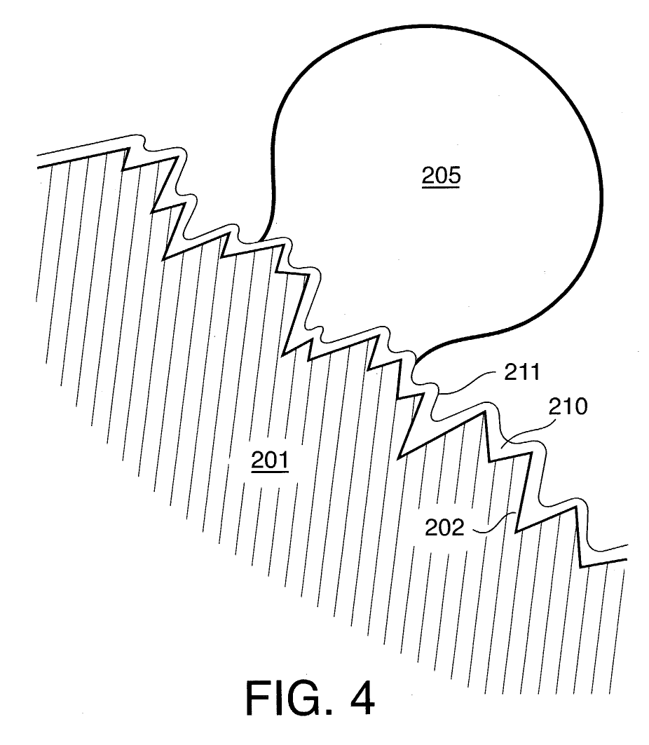

A bubble (305) on a smooth upward-facing horizontal surface (315) is shown in FIG. 3A. The maximum bubble radius R on the surface (315) is determined by the surface tension σ_{LG} of the bubble interface (307), and the contact angle θ between the surface (315) and the bubble interface (307). In particular, the buoyancy of the truncated spherical maximum-radius bubble (305) is just balanced by the surface tension binding the bubble to the surface, so

{βgπR³/3}[4−(1−cos θ)²(2+cos θ)]=2πRσ_{LG} sin² θ. (1.1)

Solving for the maximum bubble radius R provides

R={6σ_{LG} sin² θ/βg[4−(1−cos θ)²(2+cos θ)]}^{1/2}. (1.2)

The surface tension σLG for a water/carbon dioxide interface at room temperature (25° C.) is roughly 80 dynes/cm, the density β of water is 1 g/cc, and the contact angle θ is generally in the neighborhood of 25° for a confection in a carbonated beverage. Based on these values, the maximum bubble radius R is approximately 1.5 mm.

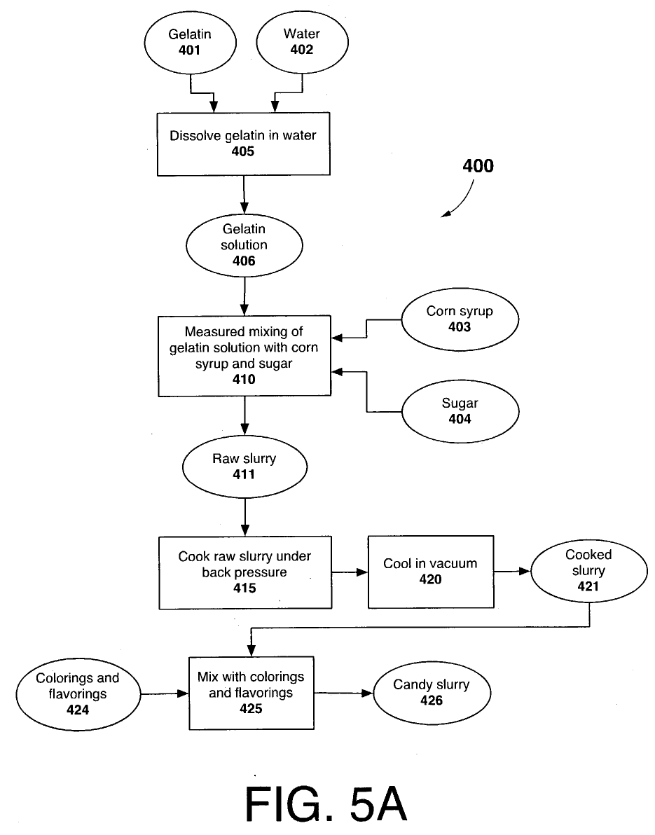

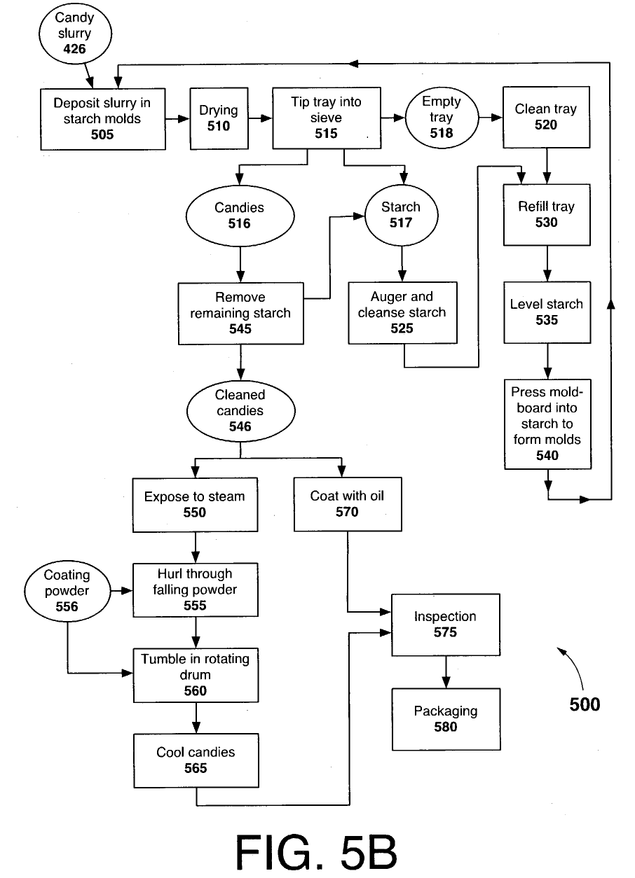

Experimentally, the maximum bubble radius R(Ω) as a function of angle Ω can be determined visually, preferably with the assistance of optical and/or photographic instruments. Alternatively, the maximum bubble radius R(Ω) can be determined by measurements of the speed of ascension of the bubbles through the beverage. Experimental graphs of the ascension speed versus bubble size are presented in FIG. 5 of “On the rise of small air bubbles in water,” P. G. Saffman, Journal of Fluid Mechanics, Volume 1, page 249, 1(956). Typically, carbonation bubbles which form on confections have a radius R of 1.4±0.3 mm.

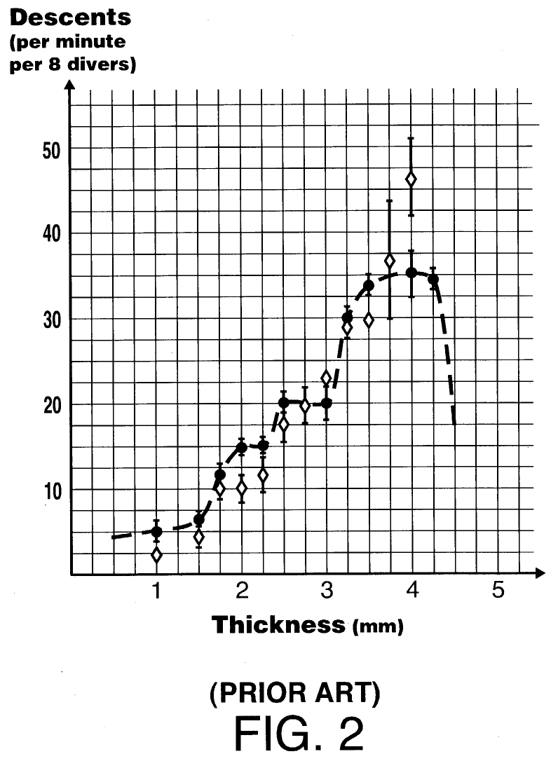

The total buoyancy provided by the population of bubbles at time t is dependent on the volume of bubbles per unit surface area, i.e., the bubble coverage h(t). The bubble coverage h(t) is given by

$$h ( t ) = {\int }_{O}^{R} ( 4 / 3 ) π {r}^{3} f ( r , t ) ⅆ r , \qquad ( 1.3 )$$

where f(r,t) dr is the size distribution of bubbles per unit area. (For ease of description in the remainder of the present specification, the orientation of the surface will generally be considered to be an upwards-facing horizontal surface, i.e., Ω=0, unless otherwise specified.) To obtain a rough idea of the relationship between h and R for a high density of bubbles, it is noted that if the bubbles all have radius R and are arranged in a hexagonal close-packing formation, the volume per unit area h is equal to (2√3πR/9)≈1.2 R. Another rough guide for a typical relationship between h and R is obtained from the data of FIG. 2. Application of the equation (2.6) (presented below) provides h≈1.2 mm, and since the maximum bubble radius R for the materials used in that experiment is roughly 1.4 mm, it follows that h≈0.86*R.

2. Physical Requirements for Ascents

When the weight of a submerged confection (10) and the attached bubbles (18) becomes less than the weight of the displaced beverage (16), the confection (10) will rise. Therefore, the confection (10) rises when

βV+β_{G}Ah(t)<β_{L}[V+Ah(t)] (2.1)

where V, A, and β are the volume, surface area and specific gravity of the confection, β_{L} and β_{G} are the specific gravity of the carbonated beverage (16) and the carbonation bubbles (18), and h(t) is the volume per unit surface area of the population of bubbles (18) on a surface of the confection (10) as a function of time t since the surface has been exposed to the atmosphere (17). The function h(t) is termed the “bubble coverage.” (It should be noted that surface roughnesses on length scales less than the maximum bubble radius R are considered to influence the bubble coverage h(t), rather than contribute to the surface area A.)

Since β_{L} and β are much greater than β_{G}, the second term on the right in equation (2.1) can be ignored. Incorporating the approximation β_{L}≈1 (where it is to be understood that the unity has units of grams/cc), the confection rises when

(β−1)V/A<h(t). (2.2)

Typically, h(t) is roughly equal to h(∞), the steady-state value of h(t), when the time t is several multiples of the time it takes a lone bubble (i.e., a bubble having no other bubbles in the vicinity with which to coalesce) to grow to the maximum radius R. (It is to be understood that in this limit the time t must still be considerably smaller than the time it takes for the beverage to lose its carbonation.) The bubble coverage h(t) is a monotonically increasing function of time, so if

(β−1)V/Ah(∞)<1, (2.3)

then the bubbles (18) on the surface of the confection (10) are able to grow to a size large enough that the confection (10) will rise.

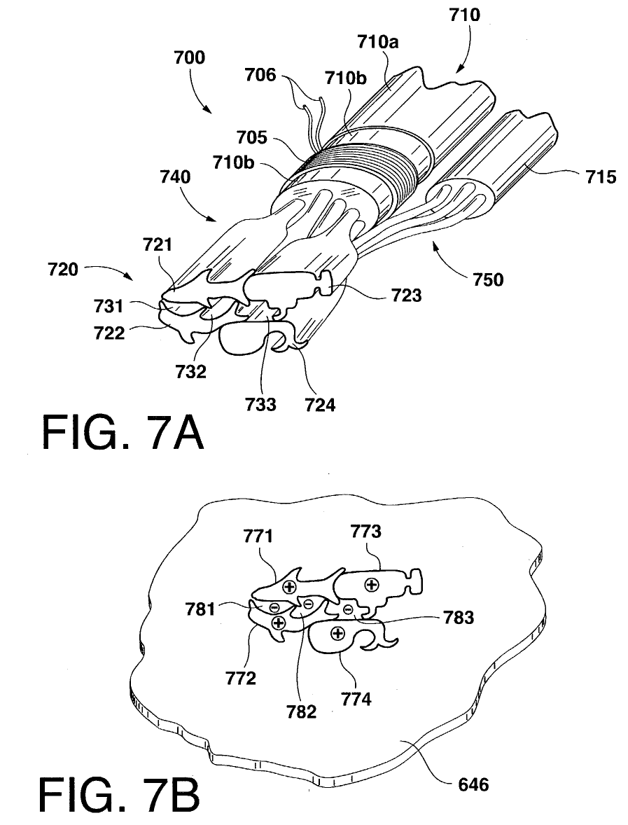

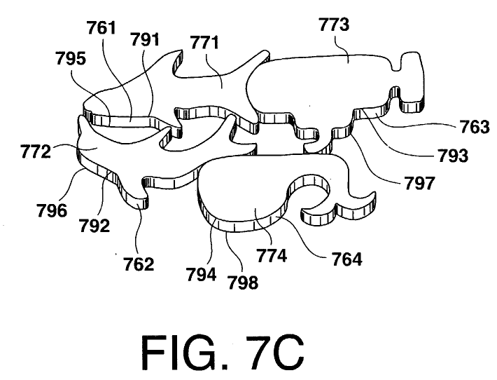

A confection (10) of widths W₁ and W₂ and thickness T is considered to be “thin” when the total surface area is considerably larger than the surface area of the thin side surfaces. A group of thin confections (771-773) is shown in FIG. 7C. A view of a thin confection (771-774) such that the normal vector of the upper or lower face along the line of viewing is considered the “plan view” of the confection (771), and the area of a plan-view face is termed the “plan-view” area. The plan-view faces of the thin confections (771-773) shown in FIG. 7C are in the shapes of a shark, dolphin, submarine and whale, respectively. Mathematically, a confection (771-774) is considered to be thin when

T<H(W₁×W₂)/(W₁+W₂), (2.4)

where H is positive with a value less than unity. In the preferred embodiment the confection is thin, and His preferably less than 0.5, more preferably 0.4, more preferably 0.3, more preferably 0.2, and still more preferably 0.1. For thin confections (771-774), the volume is approximately equal to the thickness times half the surface area (i.e., V≈T(A/2)), so the ascension condition (2.3) becomes

(β−1)T/2h(∞)<1. (2.5)

Therefore, the maximum thickness Tₘₐₓ for which ascension can occur for a given specific gravity β and steady-state bubble coverage h(∞) is given by

Tₘₐₓ=2h(∞)/(β−1) (2.6)

Although the above calculations should take into account the difference in values for the steady-state bubble coverage on upward-facing surfaces hₜₒₚ(∞) and downward-facing surfaces h_{bot}(∞), to first approximation this difference can be ignored and the value of hₜₒₚ(∞) can be used for h(∞) in the above equations. Although the value of h_{bot}(∞) can be larger than hₜₒₚ(∞), if h_{bot} is substantially greater than hₜₒₚ when the confection (10/771-774) begins to rise through the beverage (16), the greater buoyancy generated by the bubbles (18) on the lower surface will cause the confection (10/771-774) to rotate so that what had previously been the lower surface become the upper surface. Then, a substantial portion of the bubbles (18) on what becomes the upper surfaces will separate from the confection (10/771-774) so that the buoyancy contributed by this surface will be less than or equal to hₜₒₚ(∞).

3. Physical Requirements for Descents

If a confection (10) has a specific gravity β greater than the specific gravity of the carbonated beverage β_{L} (which is approximately equal to unity), the confection (10) will initially sink when put in the beverage (16). If the specific gravity and dimensions of the confection (10) are within the bounds discussed in the previous section, the confection (10) will then rise to the upper surface (12) of the beverage (16) and those bubbles (18) which contact the upper surface (12) of the beverage (16) will escape into the atmosphere (17).

Depending on the geometry of the confection (10), the confection (10) may or may not rotate when the bubbles (18) on the upper surface of the confection (10) contact the beverage/air interface (12) and escape into the atmosphere (17). A confection (10) is considered to be “round” if it rotates as the bubbles (18) on the top surface escape into the atmosphere (17), thereby allowing the bubbles (18) on the bottom surface to also escape. Therefore, if the confection (10) is round confection, it (10) will descend

β>β_{L}≅1. (3.1)

A confection (10) which is not round, is considered to be “flat.” For confections (10) which are flat there are two mechanisms for descension. If a flat confection (10) is sufficiently heavy, then the confection (10) will descend when the bubbles (18) leave the top of the confection (10) but remain on the bottom. In this case, the descension condition is

T>h_{bot}(t_{c})/(β−1), (3.2a)

or

(β−1)T/h_{bot}(t_{c})>1, (3.2b)

where t_{c} is the time for one cycle of motion, i.e., the time for the confection to descend and ascend. The value of the bubble coverage for a downward-facing surface, h_{bot}, is used since the surface which faces downward when the confection (10) descends has been facing downward nearly the entire cycle time, because when the confection (10) first descends from the beverage/atmosphere interface (12) the buoyancy of the population of bubbles (18) on the downward-facing surface causes the confection (10) to rotate so that this bubble population is on the upward-facing surface.

If the confection (10) is flat and conditions (3.2a) and (3.2b) are not satisfied (while condition (3.1) is satisfied), then the bubbles (18) must also leave the bottom surface of the confection (10) before the confection (10) can descend. In this case, the confection (10) remains at the top of the beverage (16) long enough for the bubbles (18) on the bottom of the confection (10) to coalesce to form large, somewhat flat bubbles (18). When these bubbles (18) become sufficiently large to roll off the bottom of the confection (10), the confection (10) can descend. This mechanism for descension of the confection (10) requires more time than the mechanism described in connection with condition (3.2a) or (3.2b), so the number of descents per minute per confection (10) is greater when condition (3.2a) or (3.2b) is satisfied.

4. Influence of the Beverage-Atmosphere Surface Tension on Descension of Soluble Articles

A cross-sectional view of a bubble (305) of gas which has formed in a liquid (320) on the surface (315) of a confection (310) is shown in FIG. 3A. The angle of contact θ between the surface (315) of the confection (310) and the surface (307) of the bubble (305) along the circle (318) where it contacts the surface (315) of the confection (310) is determined by: the magnitude of the surface tension σ_{LG} between the liquid (320) and the gas (305), the magnitude of the surface tension σ_{SG} between the confection (310) and the gas (305), and the magnitude of the surface tension σ_{SL} between the liquid (320) and the confection (310). In particular, the sum of the components of the three surface tensions σ_{LG}, σ_{SG}, and σ_{SL} along the surface (315) of the confection (310) is zero, i.e.,

σ_{SG}=σ_{LG} cos θ+σ_{SL}, (4.1.1)

since the location of the point of contact (318) is stationary.

Similarly, a cross-sectional view of a bead (320) of the liquid on the surface (315) of the confection (310) in a gas atmosphere (305) is shown in FIG. 3B. Again, the angle of contact θ between the surface (315) of the confection (310) and the surface (307) of the bubble (305) along the circle (318) where it contacts the surface (315) of the confection (310) is given by equation (4.1.1) so that the vector sum along the surface (315) is zero. (It is important to note that the surface (315) of the confection (310) may possibly be a liquid, such as a coating of oil. However, for ease of description in the present specification, the confection will sometimes be referred to as the “solid,” the surface tension between the confection (310) and the gas (306) will be referred to as the solid-gas surface tension σ_{SG}, and the surface tension between the confection (310) and the liquid (320) will be referred to as a solid-liquid surface tension σ_{SL}.)

In circumstances where

σ_{SG}>σ_{LG}+σ_{SL}, (4.1.2)

there is no solution for the contact angle θ in equation (4.1.1), and the liquid (320) is said to wet the confection (310). In this case, as shown in FIG. 3C, it is energetically favorable for the liquid (320) to coat the confection (310), forming two extended interfaces (i.e., an extended solid-liquid interface (352) and an extended liquid-gas interface (354)) rather than (i) a single extended interface (315a) and a bubble of gas (305) as shown in FIG. 3A, or (ii) a single extended interface (315b) and a bead of liquid (320) as shown in FIG. 3B.

There are a number of perplexing issues concerning surface tension effects on soluble articles, particularly with regards to the wetting or nonwetting of soluble articles. When a soluble article, such as a confection (10), is submerged in a beverage (16) and then withdrawn, the beverage (16) remains spread over the confection (10)—rather than beading up on the confection (10)—indicating that the soluble article is wetted by the beverage (16). However, carbonation bubbles (18) are observed to nucleate and grow on soluble articles (10) indicating that the soluble article is not wetted by the beverage (16). This is possibly due to bubbles nucleating in a soluble article slightly below the wetted outer surface, and the degree to which bubbles nucleate may therefore have some relationship to the solubility of the article or its permeability to the beverage. Although the surface tension of the beverage/atmosphere interface (12) should not affect the motion of an article that is wetted, the present invention and its descriptions herein is based on the surface tension of the upper beverage-atmosphere interface (12) having an effect on the swimming of soluble articles.

Contrary to the teaching of U.S. Pat. No. 6,319,535 (column 11, lines 51-52), it is believed that the surface (315) of the confection (310) must not be wetted in some respect which is not presently well-understood if bubbles (318) are to form on the surface (315) and there is to be a non-negligible bubble coverage h(∞), as shown in FIG. 3D. If the surface (315) of the confection (310) is not wetted, the liquid-gas surface tension σ_{LG} will provide an upwards force when the confection (310) is at the top of the beverage (320), as shown in FIG. 3D, and this will to some extent inhibit the confection (310) from descending. Therefore, according to the present invention, the system is engineered such that the liquid-gas surface tension σ_{LG} does not prevent or substantially inhibit the confection (310) from descending.

The upwards force F provided by the surface tension σ_{LG} when the confection (310) reaches the top surface (321) of the beverage (320) is given by

F=Cₑσ_{LG} sin θ, (4.1.3)

where Cₑ is the circumference of an area (311) on the confection (310) which is exposed to the atmosphere (305). According to the present invention, the upwards force F due to the surface tension σ_{LG} is not to prevent or substantially inhibit the descent of the confection (310). Therefore, the upwards force F must be somewhat less than the lost buoyancy provided by the bubbles which were at the top surface (311), but have escaped into the atmosphere (305), i.e.,

Cₑσ_{LG} sin θ<h(t_{c})β_{L}gAₑ, (4.1.4a)

where Aₑ is the area of the surface (311) which is exposed to the atmosphere (305), and t_{c} is the ascent/descent cycle time for the confection (310). Equation (4.1.4a) may be rewritten as

sin θ<h(t_{c})β_{L}gAₑ/Cₑσ_{LG}. (4.1.4b)

If the area Aₑ of the exposed surface (311), the circumference Cₑ of the exposed surface (311), and the bubble population volume per unit surface area h(t_{c}) after one cycle time t_{c} are relatively unaffected by the surfactant (see below), then according to the present invention a surfactant is chosen which reduces the quantity

σ_{LG} sin θ. (4.1.4c)

According to the preferred embodiment of the present invention, the surfactant reduces [σ_{LG} sin θ] by 5%, more preferably 10%, more preferably 15%, still more preferably 20%, even more preferably 30%, and still more preferably 50%.

However, it should be noted that the contact angle θ must not be too small since, as per equation (1.2), for small values of the contact angle θ the maximum bubble radius R decreases in proportion to the contact angle θ, i.e.,

R≈θ[3σ_{LG}/β_{L}g]^{1/2}. (4.1.5)

If the bubble coverage h(t_{c}) is roughly equal to the steady-state bubble coverage h(∞), then it is proportional to the maximum bubble radius R, i.e., h(∞)=κR, where κ is a proportionality constant. For small values of the contact angle θ, equation (4.1.4b) becomes

1<κ*[3β_{L}g/σ_{LG}]^{1/2}[Aₑ/Cₑ] (4.1.6)

It should be noted that the contact angle θ is not present in the relation of equation (4.1.6).

For a thin confection (310) with a thickness T and a cross-sectional area of roughly W₁×W₂, to insure that the surface tension σ_{LG} does not hold the confection (310) at the surface (321), equation (4.1.6) becomes

1<κ*[3β_{L}g/σ_{LG}]^{1/2}[W₁×W₂/2W₁+2W₂]. (4.1.7a)

Given that g=980 cm/sec², the surface tension σ_{LG} of an air-water interface at room temperature is roughly 72 dynes/cm, and the density β of water is 1 g/cc, and taking k≅0.8, equation (4.1.7a) becomes

1<5.1[W₁×W₂/2W₁+2W₂] (4.1.7b)

where the cross-sectional dimensions W₁ and W₂ are to be specified in centimeters. For instance, for W₁=1.5 cm and W₂=1.0 cm, the right-hand side of equation (4.1.7b) is roughly 1.5, and equation (4.1.7b) is satisfied. However, for W₁=W₂=0.5 cm, the right-hand side of equation (4.1.7b) is roughly 0.64, and equation (4.1.7b) is not satisfied. According to the present invention, equations (4.1.4b) and/or (4.1.6) and/or (4.1.7b) are satisfied. More preferably, the respective right-hand sides of equations (4.1.4a), (4.1.4b), (4.1.6), (4.1.7a) and/or (4.1.7b) are at least 10% larger than the respective left-hand sides, still more preferably at least 20% larger, still more preferably at least 33% larger, still more preferably at least 50% larger, still more preferably at least 75% larger, still more preferably at least 100% larger, still more preferably at least twice as large, and still more preferably at least four times as large. It is to be understood that since thin confections will generally not have exactly rectangular plan-view faces, the dimensions W₁ and W₂ are the effective widths of the face of the confection such that a non-rectangular confection with effective widths W₁ and W₂ will behave as a rectangular confection with actual widths W₁ and W₂. That is, the aspect ratio (W₁/W₂) is roughly equal to the aspect ratio of the major portions of the plan view of the confection, and the product (W₁×W₂) is roughly equal to the plan-view area of the thin confection.

Surfactants are chemicals which having a polar end (i.e., an end having a permanent dipole moment) and a non-polar end, and which congregate at liquid-liquid, liquid-air, and/or liquid-solid interfaces, and lower the surface tensions of the interfaces at which they congregate. At an interface, the polar end will locate in or next to the polar medium, and the non-polar end will locate in the non-polar medium. For instance, since water molecules are polar, while oils are generally not polar, surfactants at an oil-water interface will orient themselves with their polar ends in the water and their non-polar ends in the oil. Polar groups for surfactants include alcohol, carboxylic acid, dithiocarbonate, dithiophosphate, amine, sulfonate, sulfate and phosphate. There also exists a wide variety of non-polar groups.

In U.S. Pat. No. 6,319,535 (column 11, lines 26-56) it is taught that the addition of a surfactant, such as a soap or detergent, to the carbonated beverage will induce nonsoluble swimming articles to behave in a manner similar to soluble articles. In U.S. Pat. No. 6,319,535 this effect is attributed to the top surface of the surfactant producing wetting of the nonsoluble swimming article by the surfactant-bearing beverage when it reaches the beverage-atmosphere interface. Furthermore, U.S. Pat. No. 6,319,535 teaches that soluble articles, such as confections, (column 11, lines 30-36) are wetted by a beverage even if a surfactant is not present (column 11, lines 51-52), so a surfactant should not influence the activity of a soluble article.

However, as mentioned above, the wetting/nonwetting of soluble articles is presently not well understood. In particular, although when a soluble article is put in a beverage and removed it appears to be wetted, carbonation bubbles grow on a submerged soluble article, indicating that the soluble article is not wetted. However, as per the present invention, benefits of the addition of a surfactant to a carbonated beverage containing soluble swimming articles do manifest. Therefore, according to a preferred embodiment of the present invention, a surfactant is added to a carbonated beverage containing soluble swimming articles to lower the beverage-atmosphere surface tension σ_{LG} and/or the contact angle θ to satisfy the inequalities of equations (4.1.4a), (4.1.4b), (4.1.6), (4.1.7a), and/or (4.1.7b), or to increase the degree of inequality in equations (4.1.4a), (4.1.4b), (4.1.6), (4.1.7a), and/or (4.1.7b).

According to the present invention a small amount of an edible surfactant is added to a carbonated beverage containing soluble swimming articles, such as confections. According to the preferred embodiment of the present invention, the edible surfactant is a powdered or granulated coating, or a component of a powdered or granulated coating, on the surface of the soluble swimming articles, and the introduction of the articles to the beverage acts to introduce the edible surfactant to the beverage. In an alternate preferred embodiment of the present invention, the edible surfactant is a liquid coating or a component of a liquid coating on the surface of the confections, or is incorporated in a liquid coating as a powder or granules, and the introduction of the confections to the beverage acts to introduce the edible surfactant to the beverage. Alternatively, the edible surfactant may be a liquid, powder, or granules packaged with the confections so that the edible surfactant may be poured into the carbonated beverage with the confections. Alternatively, the edible surfactant may be packaged in a separate pouch, bag, or container which may be emptied into the beverage before, or shortly after, putting the confections in the beverage. It should be noted that the amount of powder or granulated material added to the carbonated beverage should be minimized since such materials induce fizzing of the carbonated beverage, and therefore produce a loss of carbonation.

Table 1 provides a listing (taken from the website, http://www.mancan.mb.ca/balked98.html, of ManCan Ingredients Inc., of Winnipeg, Canada) of the air-liquid surface tension σ_{LG} for a number of edible surfactants in solution with water at room temperature (25° C.). The surface tension (σ_{LG} of pure water at room temperature is roughly 72 dynes/cm. As can be seen from Table 1, propylene glycol alginate can lower the surface tension as much as 36%.

TABLE 1
Surface Tension of Hydrocolloids Solutions at 25° C.

| | 0.25% solution | 0.50% solution |
|---|---|---|
| | (dynes/ cm) | (dynes/ cm) |
| Agar | 65.9 | 60.0 |
| Arabic | 65.6 | 53.2 |
| CMC type 4M65F | 69.0 | 66.9 |
| Carrageenan, Calcium | 68.8 | 66.9 |
| Furcellaran | 67.9 | 66.3 |
| Gelatin | 52.7 | 48.1 |
| Ghatti | 63.8 | 45.9 |
| Guar | 68.5 | 59.4 |
| Karaya | 68.3 | 65.7 |
| Locust bean | 67.8 | 59.9 |
| Mustard Mucilage | 57.1 | 55.2 |
| Pectin | 64.2 | 67.3 |
| Propylene glycol | 46.9 | 45.8 |
| alginate | | |
| Tragacanth | 53.2 | 47.7 |
| Xanthan | 69.2 | 74.1 |

Table 2 provides a listing (taken from the website, http://www.mancan.mb.ca/balked98.html, of ManCan Ingredients Inc., of Winnipeg, Canada) of the liquid-liquid surface tension σ_{LL} of a number of edible surfactants for vegetable oil and water at room temperature (25° C.). The sans-surfactant vegetable oil-water surface tension σ_{LL} at room temperature is roughly 21.5 dynes/cm. As can be seen from Table 2, mustard mucilage can lower the surface tension as much as 58%.

TABLE 2
Surface tension of water/vegetable oil interface with
hydrocolloids in solution at 25° C.

| | 0.25% solution | 0.50% solution |
|---|---|---|
| | (dynes/ cm) | (dynes/cm) |
| Agar | 16.3 | 13.6 |
| Arabic | 16.2 | 16.0 |
| Gelatin | 11.3 | 10.2 |
| Ghatti | 19.6 | 18.9 |
| Karaya | 19.5 | 19.7 |
| Mustard Mucilage | 9.0 | 9.0 |
| Pectin | 18.9 | 18.2 |
| Propylene glycol | 12.2 | 13.4 |
| alginate | | |
| Tragacanth | 12.2 | 13.4 |

Tart, sugar-sweetened gelatin powders show superior results in enhancing the swimming activity of soluble articles in a carbonated beverage due to their rapid solution in the beverage and effectiveness as a surfactant. One such gelatin which provides good results is green apple flavor X-Treme Jell-O® gelatin dessert by Kraft Foods North America, Inc., of Rye Brook, N.Y. 10573. The ingredients of green apple flavor X-Treme Jell-O® gelatin dessert include in order of decreasing weight: sugar, gelatin, apidic acid, natural and artificial flavors, disodium phosphate and sodium citrate, fumaric acid, and food colorings. Another gelatin surfactant which has shown good results is Ralphs lime artificial flavor gelatin dessert, distributed by Inter-American Products, Inc. of Cincinnati, Ohio 4522. The ingredients of Ralphs lime artificial flavor gelatin dessert include in order of decreasing weight: sugar, dextrose, gelatin, fumaric acid, sodium citrate, salts, natural and artificial flavors, malic acid, and food colorings. Only a very small amount of these surfactants (on the order of a few grams) is necessary to produce the desired effect. Therefore, in the preferred embodiment of the present invention, the edible surfactant is a gelatin, which preferably has a low water content. Furthermore, in this preferred embodiment of the present invention, the edible surfactant is combined with an ingredient which promotes the speed of solution and/or the degree of solubility of the edible surfactant. For instance, since the solubility of a gelatin increases as the pH goes from 7 (i.e., neutral) to around 4, according to the preferred embodiment of the present invention the gelatin surfactant is combined with an edible acid, such as apidic acid, malic acid, latic acid, and/or fumaric acid, which increases the pH, preferably to a value of around 4.

5. Prevention of Sliding of Bubbles on a Liquid-Coated Surface

For a carbonation bubble growing on a rough solid surface there will be periods where the shape of the bubble and the contour of contact between the bubble and the solid surface changes abruptly so as to roughly maintain the value of the contact angle θ along the contour of contact. During these abrupt transitions the bubble may break free from the surface. Therefore, a carbonation bubble on a solid surface is most likely to grow to the maximum bubble size when the solid surface on which it grows is smooth. Hence, the bubble population will have more bubbles with radii near the maximum bubble radius R, and therefore produce a greater buoyancy, if the solid surface is smooth over length scales in the neighborhood of the maximum bubble radius R, more particularly over length scales from R to R/2, more preferably from R to R/4, and still more preferably from R to R/10.

It should be understood that in describing the smoothness/roughness of a surface it is not enough to simply measure deviations in the ‘height’ of a surface. Rather, a length along the surface must also be specified. If a surface portion of the article is smooth on a length scale of x, then height deviations on an x by x section of the surface are substantially smaller than x.

However, for a carbonation bubble on a liquid surface (such as a vegetable or mineral oil coating on a gummy candy) which is submerged in a beverage, as the carbonation bubble grows in radius it will tend to slide upwards if the liquid surface is inclined. (It should be noted that only a liquid surface which is a coating on a solid surface may have an inclination.) As the carbonation bubble slides along the surface, it may (i) coalesce with other carbonation bubbles along its path until it reaches the maximum bubble radius R and detaches from the surface, and/or (ii) dislodge other carbonation bubbles along its path, and/or (iii) reach an upper edge of the confection where the geometry of the edge may allow the carbonation bubble to detach. Therefore, the sliding of carbonation bubbles on a liquid surface will lower the volume per unit surface area, h, of carbonation bubbles on the surface.

According to the present invention, the dynamic viscosity η of the liquid is large enough, and the liquid film is thin enough, that the sliding of bubbles (18) on the surface of the confection (10), with the surface of the confection (10) being at an incline, is negligible (i.e., considerably smaller than the maximum bubble radius R) over the time scale of a cycle time t_{c}. (It should be noted that the “liquid” is not to be confused with the “beverage” which the liquid-coated article is submerged in.) More particularly, for a flat liquid film of thickness δ, the critical size of bubble radius rₛ at which the sliding of carbonation bubbles (18) begins to become non-negligible is given by

rₛ=(ηR/δt_{c}β_{L}g). (5.1)

Therefore, the speed of sliding of the carbonation bubble (18) is minimized when the quantity

Φ=(η/δt_{c}β_{L}g), (5.2)

where β_{L} is the specific gravity of the beverage, and g is the acceleration due to gravity. The dimensionless quantity (η/δt_{c}β_{L}g) will be termed the bubble sliding coefficient Φ. Therefore, according to the present invention, the bubble sliding coefficient Φ is greater than 0.1, more preferably greater than 0.25, more preferably greater than 0.5, more preferably greater than unity, more preferably greater than 1.5, still more preferably greater than 2, still more preferably greater than 3, still more preferably greater than 5, still more preferably greater than 7, still more preferably greater than 10, and still more preferably greater than 20. For instance, for a vegetable oil coating having a viscosity η of 1 poise and a thickness of 0.03 cm, with a cycle time t_{c} of 2 seconds, the bubble sliding coefficient Φ has a value of 0.07, and equation (5.2) is not satisfied. However, in the liquid coating has viscosity of 8 poise and the thickness of the coating is reduced to 0.01 cm, then the bubble sliding coefficient Φ has a value of 5.3, and equation (5.2) is satisfied.

In addition to or in lieu of satisfying or partially satisfying equation (5.2), according to the present invention the sliding of carbonation bubbles is inhibited or prevented by roughening the solid surface below the liquid surface. A solid substrate (201) having a rough surface (202) which is coated with a liquid (210) is shown in FIG. 4. The rough surface (202) shown in FIG. 4 is inclined upwards to the left, and a carbonation bubble (205) which is attached to the liquid coating (210) is inhibited from sliding upwards due to the roughness of the outer surface (211) of the liquid coating (210). According to the preferred embodiment of the present invention, the solid substrate (201) is rough on a length scale on the order of the critical bubble sliding radius rₛ, and more preferrably from a length scale on the order of the critical bubble sliding radius rₛ to a length scale on the order of the maximum bubble radius R. For instance, according to the preferred embodiment of the present invention the solid is rough length scales from rₛ/2 to R, or on length scales from rₛ/2 to R/2, or on length scales from rₛ to R/2.

6. Manufacturing Processes

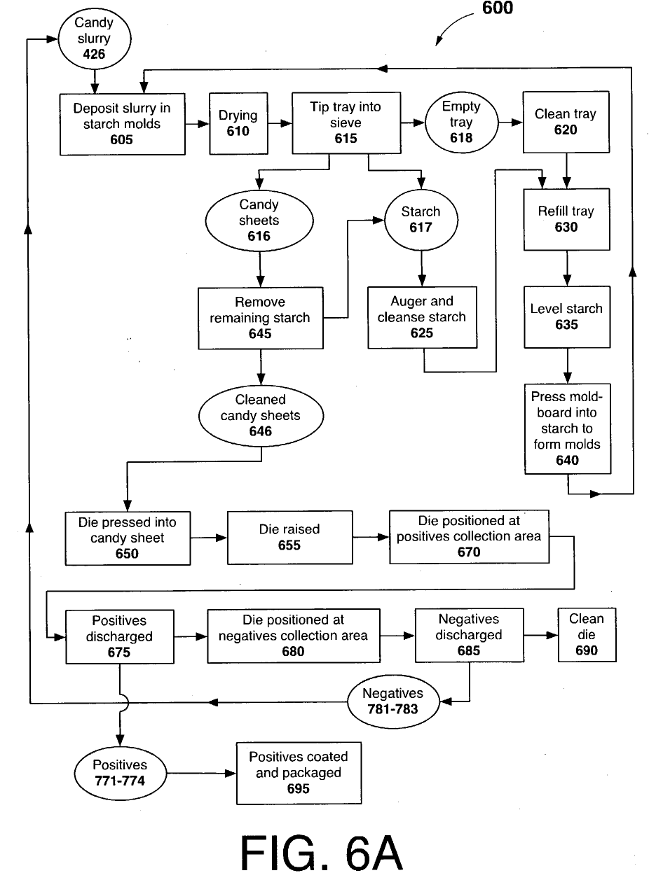

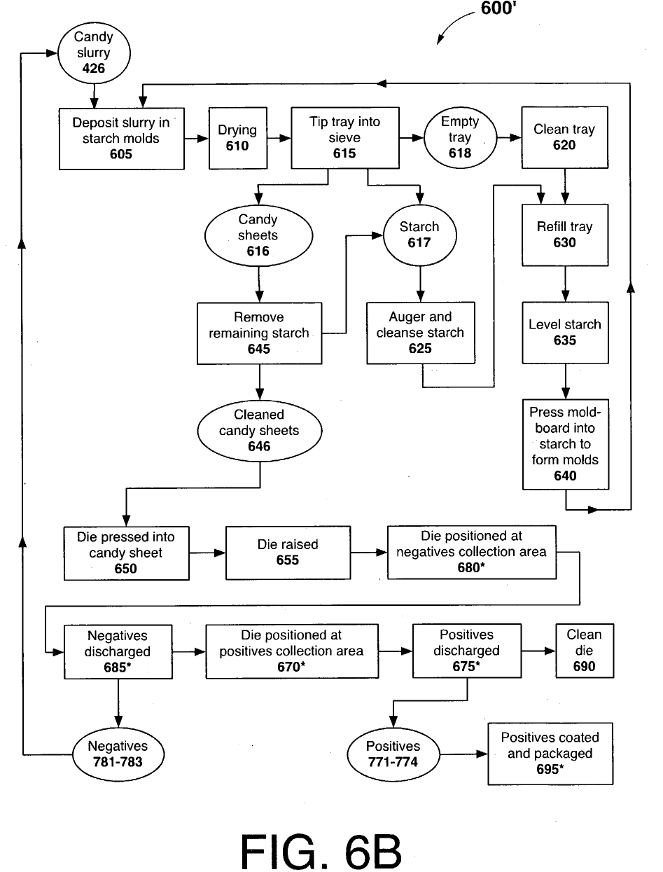

According to the present invention, candies may be given geometries with portions of narrow width, channels of narrow width, vertical side surfaces, flat upper surfaces, sharp upper edges, portions with small radii of curvature, and/or small masses by the process (600) depicted in FIG. 6A where candies are die stamped from a sheet of candy material. (It should be understood that the possible geometries of candies described herein according to the present invention are in reference to the orientation of candies when die cut from a sheet of horizontally-oriented candy material.) Die cutting of gelatin-base gummy candies, or other types of candies which are flexible, rubbery, elastic, or sticky, is problematic since removing them from a die by mechanical means without damaging the candy can be difficult or impossible. According to the present invention, the candies are discharged from a die without damaging the candies by heating the die and/or forcing the candies from the die using air pressure.

As depicted in FIG. 6A with process steps depicted as rectangular boxes and physical components depicted as ellipses, the manufacturing process according to the present invention begins by depositing (605) the candy slurry (426) into flat starch molds using one or more pour heads, as described above. (It should be noted that not all physical components are depicted in the flowcharts of FIGS. 5A, 5B, 6A, 6B, 8A and 8B and, for the physical components which are depicted in FIG. 6A, not all modifications or stages in the development of the physical components are explicitly depicted in separate elliptical boxes. Furthermore, it should be understood that although the present invention is described in FIG. 6A for use with gummy candies, the present invention may be applied to candies made of other materials/ingredients.)

The flat molds according to the process (600) of the present invention are large relative to the size of the candies to be produced, as described in detail below, so that a candy sheet (616) is produced by the mold. The mold may be so large that only a single candy sheet (616) is produced per tray.

The tray of filled molds is brought to a drying room for drying (610), typically for a period of 24 to 48 hours. If the candy sheets (616) are relatively shallow, the drying time is reduced since the loss of moisture from the entirety of the candy sheet (616) is more rapid. Once the candy slurry (426) has hardened to a consistency typical of gummy candies, the tray of starch (617) and candy sheets (616) is tipped (615) into a sieve. The sieve separates the candy sheets (616) and starch (617) since the starch (617) passes through the sieve. The starch (617) is augered and cleansed (625) to remove moisture and bacteria, and the empty tray (618) is cleaned (620) using some combination of scrapers, brushes, air blowers, etc. The cleaned empty tray (618) is then refilled (630) with the starch (617). The starch (617) in the tray (618) is then leveled (635) to insure uniformity for later stages of the molding process. The molds for the candies are made by imprinting the leveled starch using a moldboard. The moldboard is a flat plate the size of the tray (618) with a set of protruding moldpieces, which in this case have the shapes of the candy sheets (616). Pressing (640) the moldboard into the tray (618) of starch (617) compresses the starch (617), and the indentations produced by the moldpieces form the candy molds which are filled (605) with candy slurry (426), as described above. Once the candy sheets (616) are separated from the starch (617) by tipping (615) the tray (618) of starch (617) and candy sheets (616) into the sieve, any remaining starch (617) on the candy sheets (616) is removed (645) by directing compressed air jets onto the candy sheets (616) to produce cleaned candy sheets (646). The starch (617) removed at this stage (645) is combined with the starch (617) directly removed by tipping (615) the candy sheets (616) into the sieve, and the totality of the starch (617) is actually augered and cleansed (625).

The candy sheets (646) are then transported to a stamping area where a cutting die is pressed into the candy sheet (646) to sever the sheet into multiple sections. Sections cut from a thin candy sheet (646) have a geometry which is considered to be “substantially planar” according to the lexography of the present specification. An exemplary cutting die (700) shown in FIG. 7A has cutting edges (720) describing closed, co-planar loops in the shapes of silhouettes of a shark (721), a dolphin (722), a submarine (723), and a whale (724). Therefore, as shown in FIG. 7B, pressing the cutting edges (720) into the cleaned candy sheet (646) severs the cleaned candy sheet (646) as shown in FIG. 7B into positive sections (i.e., ‘positives’) (771), (772), (773), and (774) having the shapes of a shark, a dolphin, a submarine, and a whale, respectively. Furthermore, as shown in FIG. 7B, negative sections (i.e., ‘negatives’) (781), (782) and (783) of the candy sheet (646) in the spaces between the positive sections (771), (772), (773), and (774) are created by the negative spaces (731), (732), and (733), respectively, of the cutting die (700). (For ease of depiction and discussion, the exemplary cutting die (700) shown in FIG. 7A produces only four positive sections (771-774). However, it should be understood that a cutting die may produce more or fewer positives and negatives than depicted.)

As shown in FIG. 7A, the cutting edges (720) about the positive spaces (721-724) extend away from the cutting plane to form positive-section pressure pipes (740) which narrow and feed into a first master pressure tube (710). Similarly, the cutting edges (720) about the negative spaces (731-733) extend away from the cutting plane to form negative-section pressure pipes (750) which feed into a second master pressure tube (715). A heating coil (705) is wrapped around the end portion (710b) of the first master pressure tube (710). The end portion (710b) of the first master pressure tube (710), and the positive-sections pressure pipes (740) that extend from the end of the first master pressure tube (710) to the cutting edges (720) are made of a heat-conducting material. The second master pressure tube (715) and the non-end portion (710a) of the first master pressure tube (710) are made of non-heat conducting materials.

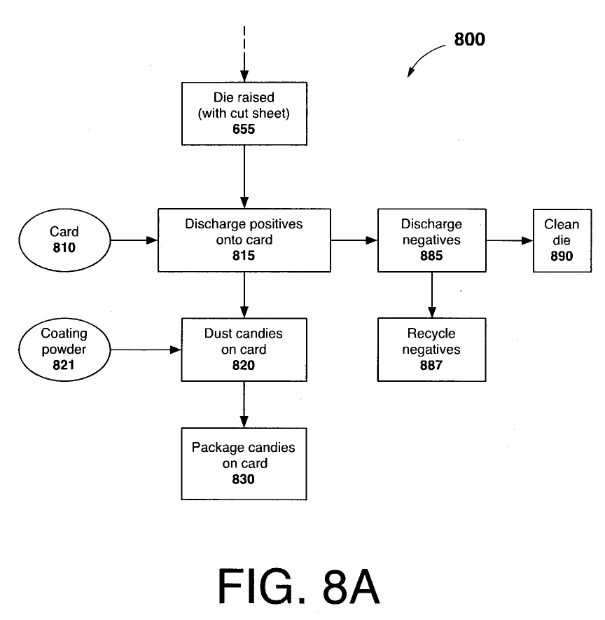

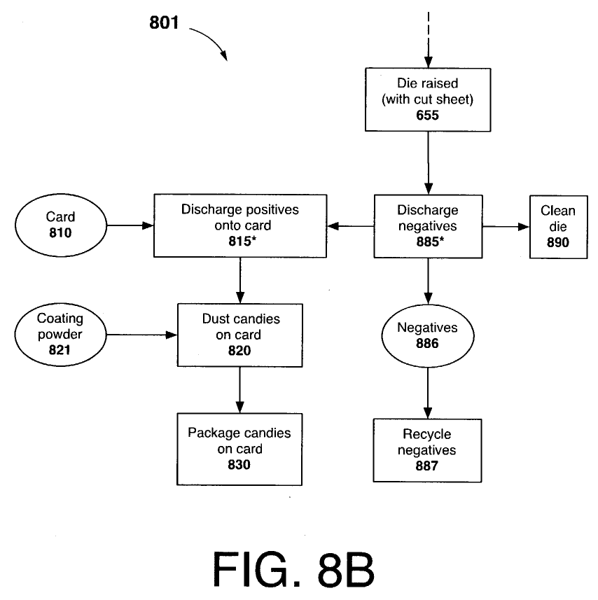

When the cutting die (700) is raised (655) after having been pressed (650) into the candy sheet (646), the positives (771-774) and negatives (781-783) remain lodged between the cutting edges (720). To insure that the positives (771-774) and negatives (781-783) remain lodged between the cutting edges (720) until the process (600) requires their dislodgement, a negative pressure (i.e., a pressure less than atmospheric pressure) is applied to the positive-sections pressure pipes (740) by a first pump (not shown) via the first master pressure tube (710) and the negative-sections pressure pipes (750) via the first master pressure tube (715). The die (700) is then positioned (670) above a positives collection area, and the positives (771-774) are discharged (675) from the cutting edges (720) while the negative (781-783) are retained by the cutting edges (720) by (i) sending a pulse of current to the heating coil (705) via heating coil power lines (706) to cause the edges of the positives (771-774) and negatives (781-783) in contact with the cutting edges (720) to melt, while (ii) applying a positive pressure (i.e., a pressure greater than atmospheric pressure) to the positive-section pressure pipes (740) by a second pump (not shown) via the first master pressure tube (710), and (iii) applying a negative pressure (i.e., a pressure less than atmospheric pressure) to the negative-section pressure pipes (750) via the second master pressure tube (715). Applying a positive pressure to the positive-section pressure pipes (740) simultaneously with, or promptly after, beginning the heating of the cutting edges (720) insures that the positives are discharged (675) before too great a region of the positives (771-774) melts, thereby insuring that the detailed shapes of the positives (771-774), which rely on the perimeter of the plan-view having portions with small radii of curvature, are preserved. The positives (771-774) are coated and packaged (695) according to standard coating and packaging procedures, or according to the method discussed below in reference to FIGS. 8A and 8B. Furthermore, the packaging process may include an additional period of drying for the melted edges of the positives (771-774).

The die (700) is then positioned (680) above a negatives collection area, and the negatives (781-783) are discharged (685) from the cutting edges (720) by applying a positive pressure to the negative-section pressure pipes (750) via the second master pressure tube (715). If the edges of the negatives (781-783) are not still molten, then another pulse of current is applied to the heating coil (705) via heating coil power lines (706) to heat the cutting edges (720) before, during or promptly after the application of the positive pressure. The die (700) is then cleaned (690) of any gummy material residues, for instance by dipping the die (700) in heated water to dissolve and wash away residues, and then drying the die (700), for instance, by blowing a heated gas, such as air, through first and second master pressure tubes (710) and (715) and over the external surfaces of the cutting edges (720). The negatives (781-783) collected at the negatives collection area may be recycled by mixing them into the candy slurry (426).

A variation (600′) of the process (600) of FIG. 6A where the order of discharging the positives (771-774) and negatives (781-783) is reversed is shown in FIG. 6B. The process (600) of FIG. 6B is the same as that of the process (600) of FIG. 6A up to (and including) the point when the cutting die (700) is raised (655) after having been pressed (650) into the candy sheet (646), with the positives (771-774) and negatives (781-783) remaining lodged between the cutting edges (720). The die (700) is then positioned (680*) above a negatives collection area, and the negatives (781-783) are discharged (685*) from the cutting edges (720) while the positives (771-774) are retained by the cutting edges (720) by (i) sending a pulse of current to the heating coil (705) via heating coil power lines (706) to cause the edges of the positives (771-774) and negatives (781-783) in contact with the cutting edges (720) to melt, while (ii) applying a positive gas pressure to the negative-section pressure pipes (750) via the second master pressure tube (715), and (iii) applying a negative gas pressure to the positive-section pressure pipes (740) via the first master pressure tube (710). The discharged negatives (781-783) may be recycled into candy slurry (426).

The die (700) is then positioned (670*) above a positives collection area, and the positives (771-774) are discharged (675*) from the cutting edges (720) by applying a positive pressure to the positive-section pressure pipes (740) via the first master pressure tube (710). If the edges of the positives (771-774) are not still molten, then another pulse of current is applied to the heating coil (705) via heating coil power lines (706). To avoid having too large a region of the positives (771-774) melt, the amount of time between the discharging (685*) of the negatives (781-783) and the discharging (675*) of the positives (771-774) should be small. The die (700) is cleaned (690) of any gummy material residues, for instance by dipping the die (700) in heated water to dissolve and wash away residues, and then drying the die (700), for instance by blowing a heated gas, such as air, through first and second master pressure tubes (710) and (715) and over the external surfaces of the cutting edges (720). The positives (771-774) are coated and packaged (695*) according to standard coating and packaging procedures, or according to the method discussed below in reference to FIGS. 8A and 8B. Furthermore, the packaging process may include an additional period of drying for the melted edges of the positives (771-774).

A typical gummy candy material melts at a temperature of around 50° C. Relative to the viscosity of a typical gummy candy material at a temperature just above the melting temperature, the viscosity of a typical melted gummy candy material is considerably reduced at a temperature of around 60-66° C., and still more considerably reduced at a temperature of around 77° C. More generally, relative to the viscosity of a typical gummy candy material at a temperature just above the melting temperature, the viscosity of a typical melted gummy candy material is considerably reduced at a temperature of around 10-15° C. above the melting temperature, and still more considerably reduced at a temperature of around 27° C. above the melting temperature. Therefore, according to the present invention, the magnitude and length of the current pulse to the heating coil (705) are sufficiently large to cause the cutting edges (720) to reach a temperature above the melting point of the gummy candy material where the viscosity is small enough that it does not substantially inhibit discharge of the candy material from the die (700). Furthermore, according to the present invention, the magnitude and length of the current pulse to the heating coil (705) are small enough, and the time from applying heat to the die (700) to discharging the positives (771-774) is quick enough, that only a very thin layer of material near the edges of the positives (771-774) melts. Therefore, according to a preferred embodiment of the present invention, upon heating, the cutting edges (720) reach a target temperature of between 0° C. and 150° C., more preferably 1° C. and 10° C., still more preferably 2° C. and 6° C., and still more preferably 30° C. and 40° C., above the melting temperature of the gummy candy material, and the positives (771-774) are promptly discharged when the cutting edges (720) reach the target temperature. Furthermore, since bubbling and splattering reduces the level of control and the degree of localization of the gummy material, the magnitude and length of the current pulse to the heating coil (705) are sufficiently small that the cutting edges (720) do not reach a temperature that produces bubbling or splattering.

As depicted in the flowchart of FIG. 8A, according to a preferred embodiment of the present invention, the die-cut positives (771-774) are transferred directly from the die (700) to a component of the packaging, such as a card (810) of grease-resistant cardstock which is to be sealed within a wrapper. This is implemented by following the process (600) of FIG. 6A up to the step (655) of raising the die (700) with the cut sheet (646) lodged between the cutting edges (720). When the cutting die (700) is raised (655) after having been pressed (650) into the candy sheet (646), the positives (771-774) and negatives (781-783) remain lodged between the cutting edges (720). The die (700) is then positioned at a height slightly greater than the thickness of the positives (771-774) above the packaging card (810), and the positives (771-774) are discharged (815) from the cutting edges (720) on to the packaging card (810) while the negative sections are retained by the cutting edges (720) by (i) sending a pulse of current to the heating coil (705) via heating coil power lines (706) to cause the edges of the positives (771-774) and negatives (781-783) in contact with the cutting edges (720) to melt, while (ii) applying a positive gas pressure to the positive-section pressure pipes (740) via the first master pressure tube (710), and (iii) applying a negative gas pressure to the negative-section pressure pipes (750) via the second master pressure tube (715). Applying a positive pressure to the positive-section pressure pipes (740) simultaneously with, or promptly after, beginning the heating of the cutting edges (720) insures that the positives are discharged (675) before too great a region of the positives (771-774) melts, thereby insuring that the detailed shapes of the positives (771-774), which rely on the perimeter of the plan-view having portions with small radii of curvature, are preserved. By discharging the positive (771-774) onto the packaging card (810) from a height not substantially greater than the thickness of the positives (771-774), the positives (771-774) remain in the arrangement that they had on the candy sheet (646), as is apparent by comparison of FIGS. 7B and 7C. The positives (771-774) on the packaging card (810) are then dusted (820) with a coating powder (821) which includes a surfactant, and packaged (830). An important advantage of this process (800) is that when the molten edges of the positives (771-774) become dry, the dried edges can act to bond the positives (771-774) to the packaging card (810). Furthermore, by dusting (820) the positives (771-774) with coating powder (821) before the edges (781-784) of the positives (771-774) become dry, only the side surfaces (761-764) of the positives (771-774) are substantially coated with coating powder (821). Since powdered surfaces do not have good bubble retension, according to the present invention this is advantageous because the non-edge surfaces of the positives (771-774) then do not retain substantial amounts of coating powder (821) and therefore maintain good bubble-retension properties. Furthermore, since the surface area with coating powder (821) is small relative to the entirety of the surface of a positive (771-774), the amount of fizzing—which is a rapid loss of the carbonation of the beverage (16), and is to be minimized if the positives (771-774) are to swim in the carbonated beverage (16) for an extended period of time—is reduced. Furthermore, since only a small amount of surfactant is sufficient to substantially affect the surface tension of the beverage (16), this method (800) still provides a sufficient amount of surfactant. Once the positives (771-774) have been powdered (820), the packaging card (810) bearing the positives (771-774) is packaged (830) as described above.

Once the positives (771-774) have been discharged (815) from the die (700), the negatives (781-783) are discharged (885) at a negatives collection area, and may be recycled (887). The die (700) is cleaned (890) of gummy material residues, for instance by dipping the die (700) in heated water to dissolve and wash away residues, and then drying the die (700), for instance, by blowing heated air through first and second master pressure tubes (710) and (715) and over external surfaces of the die (700).

An alternate method (801) of packaging the die-cut positives (771-774) on the packaging card (810) is depicted in FIG. 8B. This method is essentially the same as the method (800) described above in reference to FIG. 8A, except that after the die (700) is raised (655) with the cut sheet (646) lodged between the cutting edges (720), the negatives (781-783) are first discharged (885*) from the die (700), and then the positives (771-774) are discharged (815*) onto the packaging card (810). To avoid having too large a region of the positives (771-774) melt, the amount of time for the discharging (885*) of the negatives (781-783) and the positioning of the die (700) above the packaging card (810) must be small.

The positives (771-774) produced from the substantially planar candy sheet (646) according to the methods (600) and (600′) of the present invention are substantially planar, as shown in FIG. 7C, and if the heat applied to the cutting edges (720) by the heating coil (705) is not too great, the edges (791-798) and side surfaces (761-764) of the positives (771-744) can have much smaller radii of curvature than can be produced by the prior art method of molding (500) depicted in FIG. 5B. In particular, the upper and lower edges (791-798) of the positives (771-774) produced according to the methods (600) and (600′) of the present invention can have a radius of curvature considerably smaller than the radius of the minimum droplet size of the candy slurry (426), while candies produced by molding (500) have upper edges with a radius of curvature roughly equal to the radius of the minimum droplet size of the candy slurry (426). Furthermore, the widths of portions of the positives (771-774), such as the width of the periscope of the submarine (773), can be considerably smaller than the radius of the minimum droplet size of the candy slurry (426), while all portions of candies produced by molding (500) must have a width roughly equal to or larger than the diameter of the minimum droplet size of the candy slurry (426). Furthermore, the methods (600) and (600′) of production according to the present invention provide the advantage that detailed shapes, i.e., plan-view perimeters with portions having small radii of curvature, may be produced. Furthermore, the sharp edges (791-798) of positives (771-774) produced according to the present invention provide well-defined surface regions. This is advantageous in that the sharp, well-defined edges (791-798) facilitate the application of controlled amounts of surface layer ingredients. For instance, according to an alternate embodiment of the present invention, rather than dusting (820) the candies on the card stock with a coating powder (821), a precise amount of a liquid coating may be applied to a positive (771-774) by “painting” the liquid coating onto the thin side surfaces (761-764) of the positive (771-774). The sharp edges (791-798) of a positive (771-774) provide well-defined side surfaces (761-764), and upper and lower face areas, so, if the thickness of the liquid coating is well controlled and applied to, for instance, the side surfaces (761-764), the amount of liquid coating is well-controlled. Therefore, according to the present invention the radius of curvature of the edges (791-798) of a positive (711-774) and/or the width of one or more sections of a positive (711-774) and/or the radius of curvature of portions of the plan-view perimeter of a positive (771-774) is preferably less than 400% of the radius of curvature of the droplet size of the candy slurry (426), more preferably less than 200%, more preferably less than 100%, more preferably less than 50%, more preferably less than 33%, more preferably less than 20%, more preferably less than 10%, and still more preferably less than 5%.

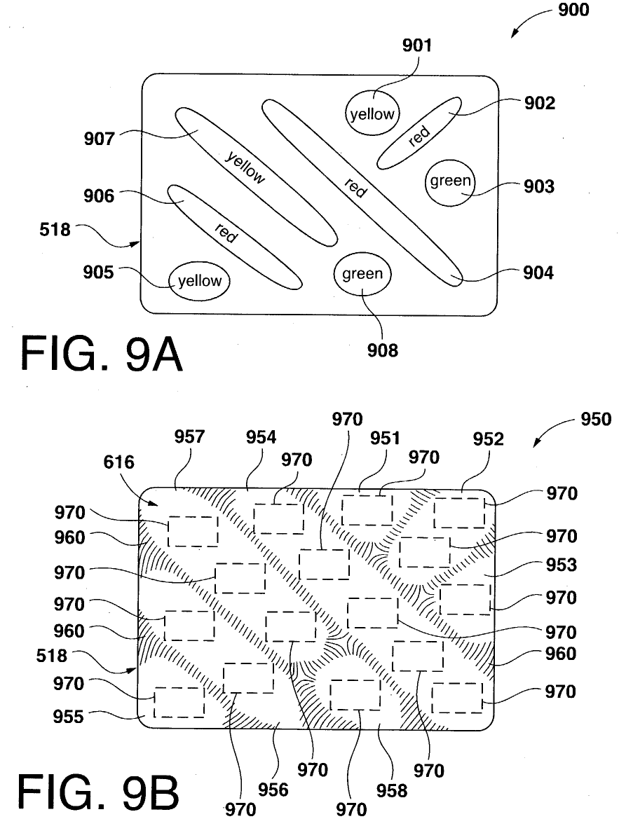

According to the preferred embodiment of the present invention, positives (771-774) having a variety of colors are manufactured and packaged by creating a candy sheet (616) having a variety of colors. This is illustrated by FIG. 9A where static pour heads have poured circular dollops of candy slurry (426) in some regions of the tray (518), and moving pour heads have poured elongated dollops of candy slurry (426) in other regions of the tray (518). Preferably, the colors and placements of the dollops (901-908) are such that the colors produced by mixing are bright and attractive. For instance, neighboring dollops having complementary colors, such as red and green, are to be avoided. In the exemplary tray (518) of FIG. 9A, static pour heads have poured the yellow dollop (905) in the bottom lefthand corner of the tray (518), the green dollop (908) near the center bottom of the tray (518), the yellow dollop (901) near the center top of the tray (518), and the green dollop (903) at the center of the righthand side of the tray (518), and moving pour heads have poured the red dollop (906) near the bottom left of the tray (518), the yellow dollop (907) extending from near the center of the tray (518) to the upper lefthand corner of the tray (518), the red dollop (904) extending from the center of the upper edge to the bottom righthand corner of the tray (518), and the red dollop (902) in the upper righthand corner of the tray (518). According to the present invention, the temperature of the tray (518) and the surrounding atmosphere is controlled so that the dollops (901-908) of candy slurry (426) spread out across the tray (518) to create a candy sheet (616) of relatively uniform-thickness, yet the colored regions (951-958) do not substantially mix. To achieve this, the temperature of the tray (518), the atmosphere, and the dollops (901-908) of slurry (426) must be high enough for a long enough period of time that the viscosity of the dollops (901-908) allows the dollops (901-908) to spread across the tray (518), yet cool enough during a period prior to the solidification of the slurry (426) that substantial fluid mixing or diffusion of the dollops (901-908) occurs before the viscosity of the candy slurry (426) increases and the candy slurry (426) begins to solidify. As shown in FIG. 9B, according to the present invention, the dollops (901-908) create a candy sheet (616) with regions (951-958) centered about the locations where the dollops (901-908), respectively, were poured, having substantially the same colors as the original dollops (901-908), and where the regions (960) where the colors of the dollops (901-908) have mixed being of relatively limited width. Dashed rectangular boxes (970) mark exemplary locations where positives having substantially the colors of the original dollops (901-908) may be extracted from the candy sheet (616). Alternatively, the positives may be extracted from regions (960) where the colors of the original dollops (901-908) have mixed, such as the region (960) between the yellow dollop (951) which is near the center of the upper edge of the tray (518) and red dollop (954) that extends to the upper righthand corner of the tray (518), which due to color mixing would be orange.

It should be noted that, in contrast with the arrangement of positives (771-774) shown in FIG. 7B, the positives (970) in the arrangement shown in FIG. 9B are not contiguous. (Positives taken from boxes (970) will also be assigned reference numeral “970” since the positives are not explicitly depicted in FIG. 9B.) The mass of each positive (970) may be made less than, on the order of, or only a few multiples of the minimum droplet size of the slurry, thereby allowing low-mass positives (970) to be produced. As the spacing between the positives (970) increases, the amount of negative material which must be recycled increases. It should also be noted that for the locations of positives (970) in FIG. 9B, the negative space between positives (970) may be cut in order to divide it into smaller regions for ease of manipulation.

The foregoing descriptions of specific embodiments of the present invention have been presented for purposes of illustration and description. They are not intended to be exhaustive or to limit the invention to the precise forms disclosed, and it should be understood that many modifications and variations are possible in light of the above teaching. The embodiments were chosen and described in order to best explain the principles of the invention and its practical application, to thereby enable those skilled in the art to best utilize the invention and the various elements of the embodiments, alone or in any combination, with various modifications as are suited to the particular use contemplated. Many other variations are possible. For example: the liquid may be supersaturated with a gas other than carbon dioxide; the invention may be applied to non-thin swimming articles; an edible surfactant other than gelatin may be used; the surfactant may or may not be combined with additional chemicals to accelerate its solution; the solid surface of the confection below the liquid coating may not be rough; the liquid coating may not be thin enough or viscous enough to inhibit the sliding of carbonation bubbles; the cutting die may be configured to divide what could be a single negative region into multiple negative regions; once the positives are deposited on the packaging card, they may be exposed to steam and powdered, or may be coated with an oil; the positives and negatives may be discharged from the die without having melted the edges of the positives and/or negatives; an additional heating coil may be located on the second master pressure tube; the heating coil may be located elsewhere, such as nearer the cutting edges or on the second master pressure tube; the cutting edges may be heated by other means; the positives may be cut from a candy sheet using a laser, or the like; the positive and negative pressures can be applied to the positive-sections pressure pipes using a single, reversible pump, or using both the intake and outtake manifolds of a single pump; the positives and negatives may be discharged from the die by other means, such as pistons; a powder other than starch may be used for the molds; the positives may be bonded to a packaging card by other means, such as an edible adhesive; the positives may be packaged without a packaging card; the positive may be deposited directly on what is to be the interior surface of the wrapper; the cutting edges may have a geometry such that the positives are completely contiguous (i.e., they have no negative spaces between them); the positives may be completely non-contiguous; the negatives may also be packaged; the positives and packaging card may be packaged in a novel or nonstandard package; the die may be cleaned by other means; etc.

Also, although the present invention has been described as involving the use of starch molds, it should be noted that the present invention can be implemented using other types of molds, such as molds coated with Teflon, or a release agent such as an oil. Furthermore, the candy sheets may be removed from the trays or molds by a method other than tipping, such as vacuum suction, compressed air, mechanical means, etc.

Furthermore, the description of the physical principles underlying the operation and performance of the present invention are also presented for purposes of illustration and description, and are not intended to be exhaustive or limiting. It should be understood that these descriptions include many approximations, simplifications and assumptions to present the basic concepts in a mathematically tractable form, and some effects which influence the operation and performance are neglected for ease of presentation. For instance: the proportionality between the steady-state bubble coverage and the maximum bubble radius may be greater than or less than that specified; the confections may or may not be wetted by the carbonated beverage, and the wetting equation may not accurately reflect the actual wetting; the contact angle may not exactly produce a sum of zero for the components of the surface tensions along the plane of a solid surface, for instance due to hysteresis effects or during transition periods; the contact angle may not have the same value over the entire contour of contact, particularly on a rough or slanted surface; the surface tensions may change with time due to the confection or its coating dissolving in the beverage; the bubble coverage after a cycle time may not be roughly equal to the steady-state bubble coverage; the specific gravity of the carbonated beverage is not exactly unity, and the specific gravity will vary as the carbonation leaves the beverage and the confection and its coating dissolve; carbon dioxide gas has a nonzero specific gravity; the surface of a carbonation bubble is not exactly spherical due to such effects as gravity; the behavior of swimming confections may be the bubble coverage as a function of time and the angle of orientation of the surface, and not just on steady-state values for an upward-facing horizontal surface; the bubbles coverage as a function of time and the angle of orientation of the surface is to some extent dependent on the carbonation level of the beverage; the bubble sliding radius may have a dependency on the parameters of the system other than as described; the bubble coverage as a function of time and the angle of orientation of the surface is dependent on the length of time the confection has been exposed to moisture (typically the moisture of the beverage); etc.

Accordingly, it is intended that the scope of the invention be determined not by the embodiments illustrated or the physical analyses motivating the illustrated embodiments, but rather by the appended Claims and their legal equivalents.

What is claimed is:

1. A confection for submersion in a carbonated beverage having a specific gravity β_{L}, the confection having a specific gravity β_{S} greater than said specific gravity β_{L} of said beverage so that the confection descends when initially submerged in said carbonated beverage, the confection having a volume V, and a surface with a first surface area A and bubble retension properties such that the confection ascends when carbonation bubbles form on the confection, an ascent and descent of the confection in said beverage occurring over an ascension/descension cycle time t_{c}, and satisfying an inequality relation
Cₑσ_{LG} sin θ<h(t_{c})β_{L}gAₑ,
where g is acceleration due to gravity, Aₑ is a second surface area exposed to the atmosphere when the confection reaches an atmosphere-beverage interface, Cₑ is a circumference of said second surface area exposed to the atmosphere when the confection reaches said atmosphere-beverage interface, σ_{LG} is a surface tension of said atmosphere-beverage interface, θ is a contact angle between said atmosphere-beverage interface and said surface of the confection, and h(t_{c}) is a bubble population volume per unit surface area after submersion of the confection for said cycle time t_{c}.

2. The confection of claim 1 further including a surface layer which includes a first soluble ingredient which increases a degree of inequality of said inequality relation.

3. The confection of claim 1 wherein said beverage includes an ingredient which increases a degree of inequality of said inequality relation.

4. The confection of claim 2 wherein [h(t_{c})β_{L}gAₑ] is at least 10% greater than [Cₑσ_{LG} sin θ].

5. The confection of claim 2 wherein [h(t_{c})β_{L}gAₑ] is at least 20% greater than [Cₑσ_{LG} sin θ].

6. The confection of claim 2 wherein [h(t_{c})β_{L}gAₑ] is at least 30% greater than [Cₑσ_{LG} sin θ].

7. The confection of claim 2 wherein [h(t_{c})β_{L}gAₑ] is at least 50% greater than [Cₑσ_{LG} sin θ].

8. The confection of claim 2 said first soluble ingredient decreases [σ_{LG} sin θ] by at least 5%.

9. The confection of claim 2 said first soluble ingredient decreases [σ_{LG} sin θ] by at least 10%.

10. The confection of claim 2 said first soluble ingredient decreases [σ_{LG} sin θ] by at least 20%.

11. The confection of claim 2 said first soluble ingredient decreases [σ_{LG} sin θ] by at least 30%.

12. The confection of claim 2 said first soluble ingredient decreases [σ_{LG} sin θ] by at least 50%.

13. The confection of claim 2 wherein
1<κ*[3β_{L}g/σ_{LG}]^{1/2}[Aₑ/Cₑ]
where κ is a proportionality constant between a steady-state bubble population volume per unit surface area h(∞) and a maximum bubble radius R, that is h(∞)=κR.

14. The confection of claim 2 wherein the confection is thin and has a plan-view face with effective dimensions of W₁ centimeters by W₂ centimeters, and wherein
1<5.1[W₁×W₂/2W₁+2W₂].

15. The confection of claim 14 wherein
1.2<5.1[W₁×W₂/2W₁+2W₂].

16. The confection of claim 14 wherein
1.5<5.1[W₁×W₂/2W₁+2W₂].

17. The confection of claim 14 wherein
2.0<5.1[W₁×W₂/2W₁+2W₂].

18. The confection of claim 14 wherein
3.0<5.1[W₁×W₂/2W₁+2W₂].

19. The confection of claim 14 wherein the confection has a thickness T such that
T<0.5[W₁×W₂/W₁+W₂].

20. The confection of claim 2 having a steady-state bubble population volume per unit surface area h(∞) such that
(βₛ−1)V/Ah(∞)<1.

21. The confection of claim 2 wherein said first soluble ingredient is a surfactant.

22. The confection of claim 21 wherein said surfactant is a gelatin.

23. The confection of claim 21 wherein said surfactant is selected from the group consisting of propylene glycol alginate, tragacanth, and mustard mucilage.

24. The confection of claim 21 wherein said readily-soluble surface layer includes a second ingredient which facilitates the solution of said surfactant.

25. The confection of claim 24 wherein said second ingredient increases the acidity of the beverage.

26. The confection of claim 25 wherein said second ingredient is selected from the group consisting of apidic acid, malic acid, latic acid, and fumaric acid.

27. The confection of claim 25 wherein said surfactant is a gelatin.

28. The confection of claim 2 wherein said confection is thin and substantially planar, and has a thin side surface and plan-view upper and lower faces, and said readily-soluble surface layer is on said thin side surface of said confection.

29. The confection of claim 28 wherein said confection has a thickness T and a plan-view face with effective dimensions of W₁ centimeters by W₂ centimeters, and wherein
T<0.5[W₁×W₂/W₁+W₂].

30. The confection of claim 29 wherein
T<0.2[W₁×W₂/W₁+W₂].

31. The confection of claim 28 wherein said readily-soluble surface layer is substantially limited to being on said thin side surface.

32. The confection of claim 2 wherein said surface layer is a powder.

33. The confection of claim 2 wherein said surface layer is a liquid.

34. The confection of claim 33 wherein said interface between said surface layer and the confection is rough on the length scale of a maximum radius of said carbonation bubbles on the confection.

35. The confection of claim 33 wherein said interface between said surface layer and the confection is rough on the length scale of a critical bubble sliding radius rₛ given by
rₛ=(ηR/δt_{c}β_{L}g),
where η is a viscosity of said surface layer, R is a maximum radius of said carbonation bubbles, and δ is a thickness of said surface layer.

36. The confection of claim 33 wherein a bubble sliding coefficient Φ given by
Φ=(η/δt_{c}β_{L}g),
is greater than 0.25, where η is a viscosity of said surface layer, R is a maximum radius of said carbonation bubbles, and δ is a thickness of said surface layer.

37. The confection of claim 36 wherein said bubble sliding coefficient Φ is greater than 0.5.

38. The confection of claim 36 wherein said bubble sliding coefficient Φ is greater than unity.

39. The confection of claim 36 wherein said bubble sliding coefficient Φ is greater than two.

40. The confection of claim 36 wherein said bubble sliding coefficient Φ is greater than four.

41. A method of producing candies from a candy sheet, comprising the steps of:
pressing a cutting die into said candy sheet to sever said candy sheet into a plurality of positives spanning closed-loop cutting edges of said cutting die;
withdrawing said cutting die from said candy sheet while retaining said positives in said cutting die;
positioning said cutting die at a positives collection area;
expelling said positives from said cutting die into said positives collection area.

42. The method of claim 41 wherein said candy sheet is made of gummy candy.

43. The method of claim 41 wherein said candy sheet is made of a candy material which is elastic.

44. The method of claim 41 wherein said candy sheet is made of a candy material which is rubbery.

45. The method of claim 41 wherein said candy sheet is made of a candy material which is flexible.

46. The method of claim 41 wherein said candy sheet is made of a gelatin-base candy material.

47. The method of claim 41 further including the step of forming said candy sheet by pouring dollops of candy slurries of a plurality of colors into a tray.

48. The method of claim 47 wherein at least one of said dollops is poured from a moving pourer so that said at least one of said dollops is non-circular.

49. The method of claim 47 wherein heat is applied to said dollops to promote spreading of said dollops on said tray.

50. The method of claim 49 wherein said heat is applied to said dollops via said tray.

51. The method of claim 47 wherein heat is removed from said dollops to inhibit mixing of said dollops on said tray.

52. The method of claim 41, wherein said expelling of said positives includes the step of heating said cutting edges to a target temperature above a melting temperature of the positives to produce melted regions at edges of said positives.

53. The method of claim 52 wherein said target temperature is between 0° and 15° C. above said melting temperature.

54. The method of claim 52 wherein said target temperature is between 1° and 10° C. above said melting temperature.

55. The method of claim 52 wherein said target temperature is between 2° and 6° C. above said melting temperature.

56. The method of claim 41 wherein said positives collections area includes a packaging sheet over which said positioning occurs and onto which said expelling occurs.

57. The method of claim 56 wherein said packaging sheet is a packaging card.

58. The method of claim 56 wherein said melted regions, upon drying, bond said positives to said packaging sheet.

59. The method of claim 52 further including the step of dusting said positives with a powder coating while said melted regions remain melted so that said powder coating adheres predominantly to said edges of said positives.

60. The method of claim 52 wherein said retaining of said positives includes the step of applying a negative pressure within said cutting die, and said expelling of said positives includes the step of applying a positive pressure within said cutting die.

61. The method of claim 41 wherein said retaining of said positives includes the step of applying a negative pressure within said cutting die, and said expelling of said positives includes the step of applying a positive pressure within said cutting die.

62. The method of claim 41 wherein said withdrawing of said cutting die includes retension of negatives in said cutting die, and further including the steps of:
positioning said cutting die at a negatives collection area;
expelling said negatives from said cutting die into said positives collection area.

63. A tool for creating candies from a candy sheet, comprising:
a first master pressure tube which bifurcates in a first bifurcation region into first subsidiary pressure tubes having first ends which are co-planar and form first cutting edges of a cutting die;
a first means for applying negative pressure to said first master pressure tube, and thereby to said first subsidiary pressure tubes, to retain first material spanning said first cutting edges; and
a second means for applying positive pressure to said first master pressure tube, and thereby to said first subsidiary pressure tubes, to expel said first material spanning said first cutting edges.

64. The tool of claim 63 wherein said first means for applying said negative pressure and said second means for applying said positive pressure is a reversible pump.

65. The tool of claim 63 wherein said first means for applying said negative pressure and said second means for applying said positive pressure are intake and outtake manifolds of a pump.

66. The tool of claim 63 further including a first means for heating said first cutting edges to a temperature above a melting temperature of said candies.

67. The tool of claim 66 wherein said first cutting edges and first portions of said first subsidiary pressure tubes adjacent said first cutting edges are made of a first heat conducting material.

68. The tool of claim 66 wherein a second portion of said first master pressure tube away from said first bifurcation region is made of a first non-heat conducting material.

69. The tool of claim 63 further including:
a second master pressure tube which bifurcates in a second bifurcation region into second subsidiary pressure tubes having second ends which are co-planar with said first ends and form second cutting edges of said cutting die;
a third means for applying negative pressure to said second master pressure tube, and thereby to said second subsidiary pressure tubes, to retain second material spanning said second cutting edges; and
a fourth means for applying positive pressure to said second master pressure tube, and thereby to said second subsidiary pressure tubes, to expel said second material spanning said second cutting edges.

70. The tool of claim 69 wherein a first portion of said first cutting edges are coincident with a second portion of said second cutting edges.

71. The tool of claim 63 wherein said candies have masses which are not considerably greater than a droplet mass of a candy slurry used to create said candy sheet.

72. The tool of claim 71 wherein said masses are less than four times said droplet mass of said candy slurry used to create said candy sheet.

73. The tool of claim 71 wherein said masses are less than two times said droplet mass of said candy slurry used to create said candy sheet.

74. The tool of claim 71 wherein said masses are less than said droplet mass of said candy slurry used to create said candy sheet.

75. The tool of claim 71 wherein said masses are less than half said droplet mass of said candy slurry used to create said candy sheet.

76. The tool of claim 71 wherein said masses are less than a quarter of said minimum mass of said droplet of said candy slurry.

77. The tool of claim 63 wherein at least one of said candies has a surface portion with a surface radius of curvature which is not considerably greater than a droplet radius of curvature of a droplet of a candy slurry used to create said candy sheet.

78. The tool of claim 77 wherein said surface radius of curvature is less than two times said droplet radius of curvature.

79. The tool of claim 77 wherein said surface radius of curvature is less than said droplet radius of curvature.

80. The tool of claim 77 wherein said surface radius of curvature is less than half of said droplet radius of curvature.

81. The tool of claim 77 wherein said surface radius of curvature is less than a quarter of said droplet radius of curvature.

82. The tool of claim 77 wherein said surface radius of curvature is less than an eighth of said droplet radius of curvature.

83. The tool of claim 77 wherein said surface portion is an upper edge of said at least one of said candies.

84. The tool of claim 77 wherein said surface portion is a side surface of said at least one of said candies.

85. The tool of claim 84 wherein said candies are thin and said side surface is a thin side surface.

86. A tool for creating candies from a candy sheet, comprising:
a cutting die having cutting edges which are co-planar and form closed loops; and
a means for heating said first cutting edges to a temperature above a melting temperature of said candies.

87. The tool of claim 86 wherein said cutting edges are made of a first heat conducting material.

88. The tool of claim 86 wherein said candies have masses which are not considerably greater than a droplet mass of a candy slurry used to create said candy sheet.

89. The tool of claim 88 wherein said masses are less than two times said droplet mass of said candy slurry used to create said candy sheet.

90. The tool of claim 88 wherein said masses are less than said droplet mass of said candy slurry used to create said candy sheet.

91. The tool of claim 88 wherein said masses are less than half said droplet mass of said candy slurry used to create said candy sheet.

92. The tool of claim 86 wherein at least one of said candies has a surface portion with a surface radius of curvature which is not considerably greater than a droplet radius of curvature of a droplet of a candy slurry used to create said candy sheet.

93. The tool of claim 92 wherein said surface radius of curvature is less than half of said droplet radius of curvature.

94. The tool of claim 92 wherein said surface radius of curvature is less than a quarter of said droplet radius of curvature.

95. The tool of claim 92 wherein said surface radius of curvature is less than an eighth of said droplet radius of curvature.

96. The tool of claim 92 wherein said surface portion is an upper edge of said at least one of said candies.

97. The tool of claim 92 wherein said surface portion is a side surface of said at least one of said candies.
